(19) United States
(12) Patent Application Publication
(10) Pub. No.: US 2007/0192176 A1
(43) Pub. Date: Aug. 16, 2007

(54) COMPUTERIZED VOTING SYSTEM

(76) Inventor: DANIEL WILLIAM ONISCHUK, Edmonton (CA)

Correspondence Address: DAN ONISCHUK, 9628 100A ST, EDMONTON, AB, T5K 0V8, CA

(21) Appl. No.: 11/738,191

(22) Filed: Apr. 20, 2007

Related U.S. Application Data
(63) Continuation of application No. 11/627,174, filed on Jan. 25, 2007.
Application No. 11/627,174 is a continuation of application No. 11/161,752, filed on Aug. 16, 2005, now abandoned.

(51) Int. Cl. G06F 11/00

(52) U.S. Cl. 705/12

(57) ABSTRACT

Any business, individuals, groups of people, or government that is Officially facilitating the voting process use sources of computer data and other data to create lists of every eligible Voter. The List of Eligible Voters contains the name and physical mailing address for each Voter. The Official host then arranges for printing of mailing envelopes containing specially designed ballots to the Voters. Each MASTER Ballot has two parts—a PRIMARY Ballot and at least one RECEIPT Ballot. For each MASTER Ballot, both the PRIMARY Ballot and RECEIPT Ballot(s) share an identical, unique group of symbols as a correlating identifier. The identifier (RSID) is randomly generated to be unique and rare, so as to make any ballot impossible to counterfeit, which is further complemented by other security features. To maintain privacy, Voters exchange unused ballots any number of times within their voting region. Ballot validation prior to exchange is performed in person, by telephone, fax or Internet. Completed PRIMARY Ballots are mailed, delivered in-person or otherwise delivered electronically via Internet, Telephone, Fax or Email to Official host by the due date for verification, recording, tallying and publication. By referring to any RECEIPT Ballot having the same the unique BALLOT VOTING RSID as the PRIMARY Ballot, any Voter can use the correlated BALLOT PASSCODE or VOTER PIN and a telephone or a computer connected to the Internet to enquire, verify and report errors as to their Ballot processing. By publishing a list of all the BALLOT VOTING RSID's after Voting is completed, candidates, Voters and the media are able to verify each Ballot cast, the Voter selections on each Ballot cast, and the final tally for each Ballot Selection—thus providing a transparent, verifiable audit trail to assure the completeness, accuracy and validity of the Voting Session.

### PURPOSE OF INVENTION

Secure Processing of Voting Ballots

### TECHNICAL PROBLEMS RESOLVED

1. improve accuracy, time and money savings of compiling voter lists;
2. extend the process of voting to encompass more voters by providing significantly easier access to the process of voting;
3. extend the process of voting to encompass candidates, proposals or any combination of candidates and proposals;
4. maintain security, privacy and anonymity of voter ballots cast;
5. enable voters to anonymously verify and correct the accuracy of official records of any ballots they have cast, by using electronic devices connected to communications networks;
6. prevent counterfeit ballots by special security elements and methods;
7. enable voters to verify ballots authenticity and validity by using electronic devices connected to communications networks;

### INVENTION USES

1. Elections to select political candidates to Government duty.

2. Corporate group of stockholders vote to elect a Chief Executive Officer.

3. Public vote on passing a Government Bill Proposal as a Public Law.

4. Stockholders vote to accept or reject proposals on business activities.

### BACKGROUND OF INVENTION

Although this invention was conceived without reference to existing patents, it should be noted this invention differs from several existing patents significantly. The purpose of this patent is to overcome the following issues and limitations of existing patents:

### CROSS REFERENCE TO RELATED APPLICATIONS

| | | |
|---|---|---|
| 3141976 | May 1974 | Hune |
| 6640138 | April 2003 | Hall & Schwartz |
| 6722562 | April 2004 | Weiss |
| 6971574 | December 2005 | Herskowitz |
| 6688517 | February 2004 | McClure |
| 6457643 | October 2002 | May |
| 6726090 | April 2004 | Kargel |
| 5878399 | March 1999 | Peralto |

Although Hall & Schwartz refer to the use of scanning devices and scannable barcodes, the barcodes themselves are not easily human readable, nor easily compatible with translation for telephone or internet use. The patents of Herskowitz requires voters to submit their Voter Identification which is embedded and linked directly to their ballot choices, and although privatized for communications with a random ID, the voters choices are clearly linked to the voter identity. Possibly Herskowitz adapted date & time stamping and a random ID concept for encryption from my prior published applications of 2004 & 2005, however, Herskowitz does not employ the Random ID concept directly to the BALLOT VOTING RSIDentifier—he employs a repeatable hashing algorithm—which can generate identical output for similar inputs. Ballot Random ID concept is unique among inventions.

In addition to the public Ballot Random System ID (RSID) used to verify authenticity of the ballot, my invention includes the improvement of having a private Voting RSID, which is known only to the Voter who reveals it for use casting a vote. In addition, a private Voter PIN is also optionally employed to enable the Voter to further personalize and secure their ballot selections information. Finally, another unique element of this invention is the use of voting signature stamps. All my prior application(s) have always included additional concepts of date/time stamping ballots, records & events as noted on my ballot drawings and reference text. Each voters selections is concatenated with their choices to generate a signature string which may be stored as is, or combined with elements such as the date, time, BALLOT VOTING RSID, BALLOT PASSCODE, Voter PIN to create a unique, non-repeatable signature, that may also be further verified by computers running software algorithms that are able to extract the unique signature individual data components by using the unique signatures meta-data that is encrypted (using methods such as, but not limited to: public-private key pair encryption) and transmitted with the unique signature.

Hall & Schwartz, et al, implicitly violates Voter privacy as the there are means to link any persons vote to the ID number they are assigned for voting, such as visual observations of ID number, electronic interception of a generated ID number. Any Voter can also be linked to a ballot by witnesses as to the date, time and place where the ballot is cast, which can also be said for the patent of May who claims “7. A ballot paper as claimed in claim 5 or claim 6 wherein the unique identifier is generated from a Voter's position on an electoral roll, the date and time the ballot paper was issued, and an external value contributed by a key.”; Thus Officials could know when & where the specific BALLOT VOTING RSID Identifier was issued to a specific person, therefore the alleged privacy is penetrable through observation and deduction. Electronic surveillance technology could also be used to detect electromagnetic waves emitted from devices issuing IDs which could then be sent to a portable computer that use software to determine any Voter ID within detection range. The patent of Weiss involves the use of Automated Teller Machines also links a Voter to a specific card and their personal identity number (PIN). Although ATM voting cards could be exchanged among Voters, ATM machines have cameras which would record the Voters face, along with the location, date and time of the ballot cast from that particular ATM. The massive coordination of banks with government and privacy issues may prevent adopting this method. Furthermore, the magnetic field of ATM cards may be easily corrupted. Due to some similarities, it should be re-emphasized that this patent was initially conceived without prior knowledge of Kargel, Weiss, or Herskowitz, yet, this invention overcomes many disadvantages of those patents by specifically defining unique methods:

a. of creating computer data lists to identify eligible Voters;

b. of unique identifiers to trace Registration Forms and Ballot distribution to eligible Voters;

c. of providing Voters with information to facilitate voting;

d. to decouple Voters from specific ballots to provide vote anonymity;

e. to provide instructions to enable voters to complete forms & ballots with minimal help;

f. of collecting ballots and registrations from Voters and tracking the items received;

g. to use unique identifiers to distinguish PRIMARY Ballots and their duplicates to prevent multiple voting using both ballots at different voting locations;

h. of Telephonic or Internet voting that does not enable the Official person to link a specific BALLOT VOTING RSID to a specific Voter (in Kargel & Herskowitz how does the Official person know the Voter is legitimate and still protect Voter privacy by providing an identifiable ballot?)

i. of using at least one computer or telephone communication network; to facilitate ballot issuance, ballot replacement, ballot Validation, and private verification of voting;

j. ensuring ballots may not be counterfeited, to prevent unfair influence in voting results;

k. to provide ballots with Security Elements to assist with Authentication;

l. of providing symbols and data on the ballot to reduce human processing;

m. of voting for people, proposals, or, any combination of people and proposals;

n. of associating an expiry date &/or time on registration forms & ballots to limit their use;

o. for audits and validation, transaction linking to voter actions, ballots and registrations;

as well as to actions by officials and officials computers processing autonomously;

To the requirements set by patent-pioneer Hune, this patent adds: (a.) to assist the principles of democracy by making it easier for people to participate in voting, thereby extending the representation of Voters to better reflect public choices. (b.) to ensure the integrity of the ballots so that the processing and voting selections may be verified and adjusted by the Voter and Official persons upon detection of any processing errors after the ballot has been processed. (c.) use of a Random Symbolic ID (RSID) and security elements to ensure the integrity of the ballots so that any Ballot may not be easily duplicated, in any quantity to significantly affect the overall percentage of vote tallies, and any such duplicates would be immediately detected and removed for further investigation and authentication so as guarantee the integrity of the final tally and certified results.

### SUMMARY OF INVENTION

The present invention provides a method and system that improves and extends the tasks of certifying eligible voters, voter participation, ensuring accurate vote reception, tallying, verification, and error reporting. The major components of the method involve providing specially designed Ballots to a group of voters; recording Ballots received from the group of voters; tallying the votes from Ballots that were authenticated and validated; publishing the vote tallies from the group; verifying the published Ballot votes and tallies on a per-voter basis; and certifying the groups tallied Ballot votes were accurately recorded and counted. Systems are also taught herein for accomplishing these tasks in several ways, namely by:

1. acquiring information from computer databases and other sources to organize and construct any number of Lists of Eligible Voters; and furthermore, Lists of Officials, and other data relevant to the Voting Session.

2. a Paper Voting method employing the use of a carbon copy or carbonless copy paper MASTER Ballot which comprises of a unique identifier; furthermore that this identifier be extremely difficult to guess, such as, but not limited to: Random Symbolic Identifiers, or, sequential series of unique identifiers, or, a hybrid of random and sequential identifiers;

3. the use of specially designed Security Elements for authentication and Limits of Use data;

4. the use of optical barcodes and other codes to facilitate computer processing;

5. use of Telephone Voting methods;

6. the use of electronic facsimile (FAX) Voting methods;

7. using Internet Voting methods (such as but not limited to: webpage, electronic mail);

8. the use of audio voting method;

9. the use of a video voting method with optional audio;

However, the particular systems discussed herein are given as some of the illustrations of particular embodiments of the invention. Other embodiments of the invention are expected to employ differing degrees of automation in providing, validating, authenticating, recording, tallying, publishing, certifying recorded and tallied votes. The systems taught and described herein are not intended to limit the application of the method claimed. The method of the invention must involve instrumentalities and combinations having different manifestations of representation, physical sizes and characteristics to suit the many corresponding physical limitations, abilities, and requirements that bear on a particular voting session or the available technology used to achieve some purpose for any voting session. The spirit of this invention will be fulfilled as long as the principles of ensuring all Eligible Voters have anonymity when casting their initial ballots, and may anonymously verify or report errors regarding the record of their ballots, thus ensuring the election system provides the intended equality for each vote cast. Accordingly, it is an object of the present invention to provide a voting method and system that allows one or more voters to completely verify the accurate recording, tally and publication of each vote on any Proposal or Candidate or any number of combinations of candidates and proposals; and it is a further object of the invention to provide: (a) a voting method and system that allows each Voter and Official to verify their votes on any Proposal or Candidate was correctly recorded, tallied and published; (b) each voter with a private receipt ballot record of the voter's primary ballot vote; (c) a public post-polling record of all votes cast on a proposal or candidate; (d) the capability for voters to use their private receipt ballot records of their cast primary ballot votes to verify or authorize correction of the public record of all ballots and votes cast; (e) the capability for voters to use the verified or corrected public record of all votes cast to verify or authorize correction of the tallies or summaries of votes; (f) vote verification and/or vote correction capabilities in a voting method or system that utilizes any physical, or, electronic, or, optical means of providing, receiving, recording validating, verifying, authenticating, tallying, summarizing, publishing and certifying: votes, ballots records, tallies, summaries or results; (g) a voting system the capability for voters to use the records of all Eligible Voters to verify or authorize correction of their name and contact information to any list of Eligible Voters; (h) vote verification and/or vote correction capabilities in a voting method or system that utilizes any physical, or, electronic, or, optical means of providing, receiving, recording validating, verifying, authenticating, tallying, summarizing, publishing and certifying any records, tallies, summaries or publications of any List of Eligible Voters. In addition to the foregoing, further, objects, features, and advantages of the present invention should become more readily apparent to those skilled in the art upon a reading of the following detailed description in conjunction with the drawings, wherein there are shown and illustrated as examples of embodiments of the invention. It is evident that those skilled in the art may now make numerous other uses and modifications of and departures from the specific embodiments described herein without departing from the inventive concepts. Consequently, this invention is to be construed as embracing each novel feature or novel combination of novel features present in or possessed by the methods and techniques herein disclosed and as such, is not to be limited to the spirit or scope of these descriptions, disclosures, appended claims or drawings.

There are 24 (TWENTY-FOUR) drawings included for this invention.

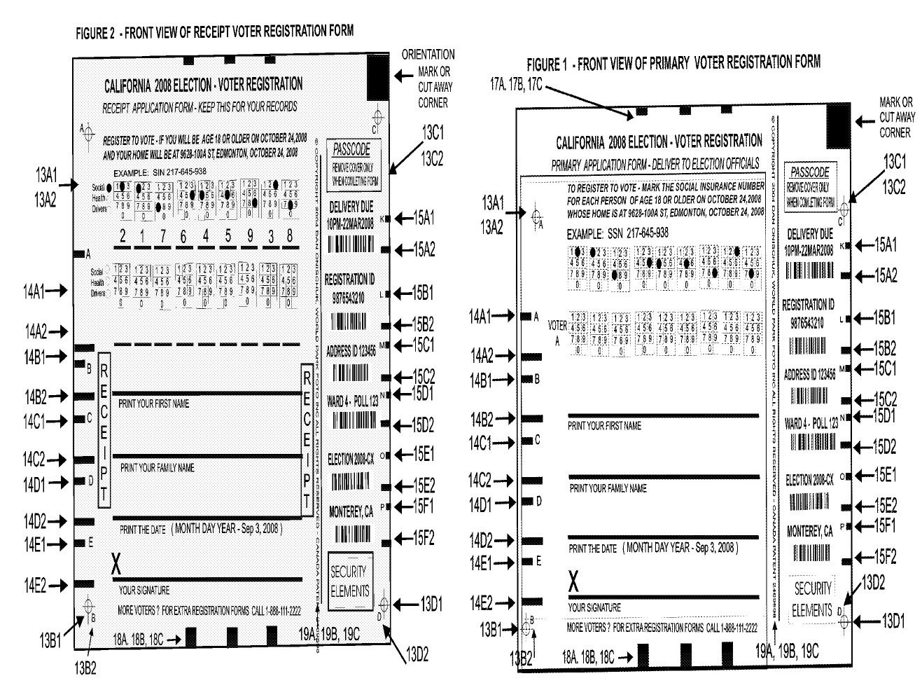

FIG. 1: a site plan view for the FRONT side of a first embodiment of a PRIMARY part of a Master Voter Registration form of the invention.

FIG. 2: a site plan view for the FRONT side of a first embodiment of a RECEIPT part of a Master Voter Registration form correlated to FIG. 1 of the invention.

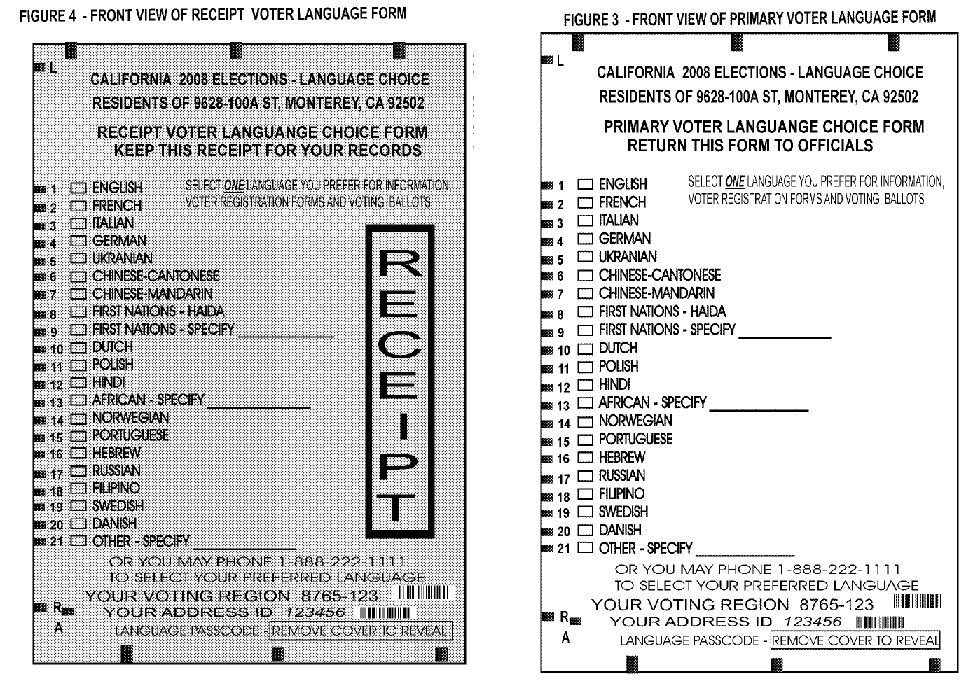

FIG. 3: a site of view for the FRONT side of a first embodiment of a PRIMARY part of the Master Voter Language Registration of the invention;

FIG. 4: a site of view for the FRONT side of a first embodiment of a RECEIPT part of the Master Voter Language Registration correlated to FIG. 3 of the invention;

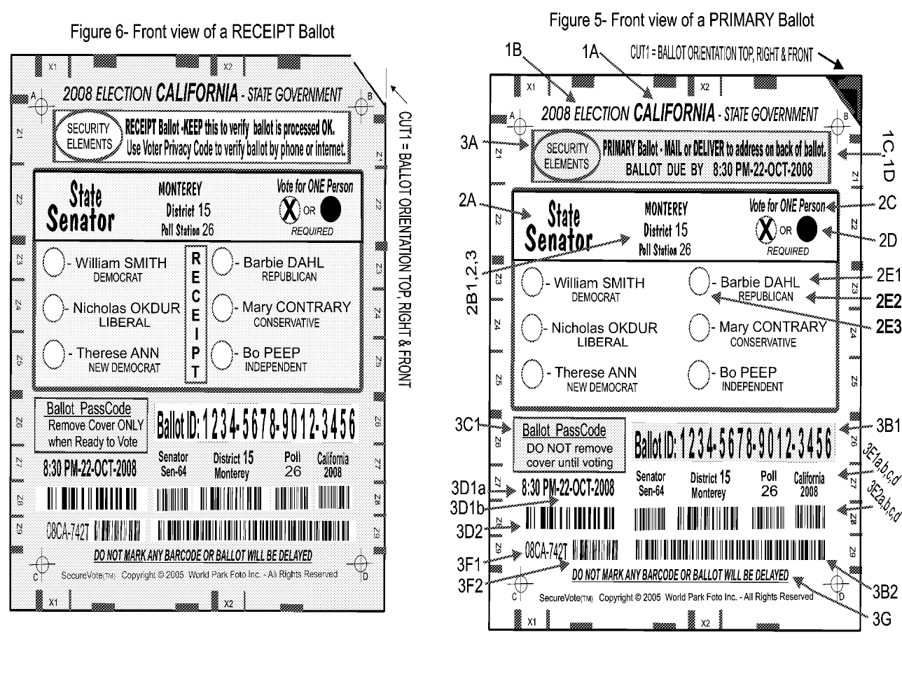

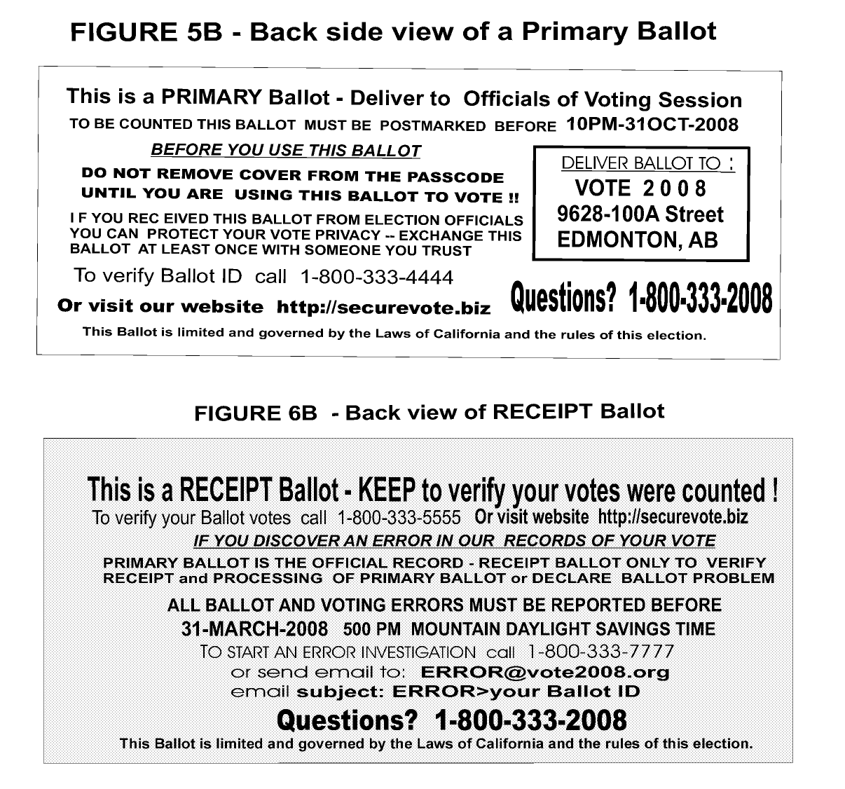

FIG. 5: a site plan view for the FRONT side of a first embodiment of a PRIMARY part of a Master Ballot of the invention.

FIG. 5B: a site plan view for the BACK side of a first embodiment of a PRIMARY Ballot, correlated to FIGS. 5,7,9,13,18,19,20,21 of this invention; and with further modification, FIG. 5B may then be correlated to FIG. 1 for Voter Registration forms, or, FIG. 3 for Voter Language forms of this invention;

FIG. 6: a site plan view for the FRONT side of a first embodiment of a RECEIPT part of a Master Ballot correlated to FIG. 5 of the invention.

FIG. 6B: a site plan view for the BACK side of a first embodiment of a RECEIPT Ballot, correlated to FIGS. 6,8,10 of this invention; and with further modification, FIG. 6B may then be correlated to FIG. 2 for Voter Registration forms, or, FIG. 4 for Voter Language forms of this invention;

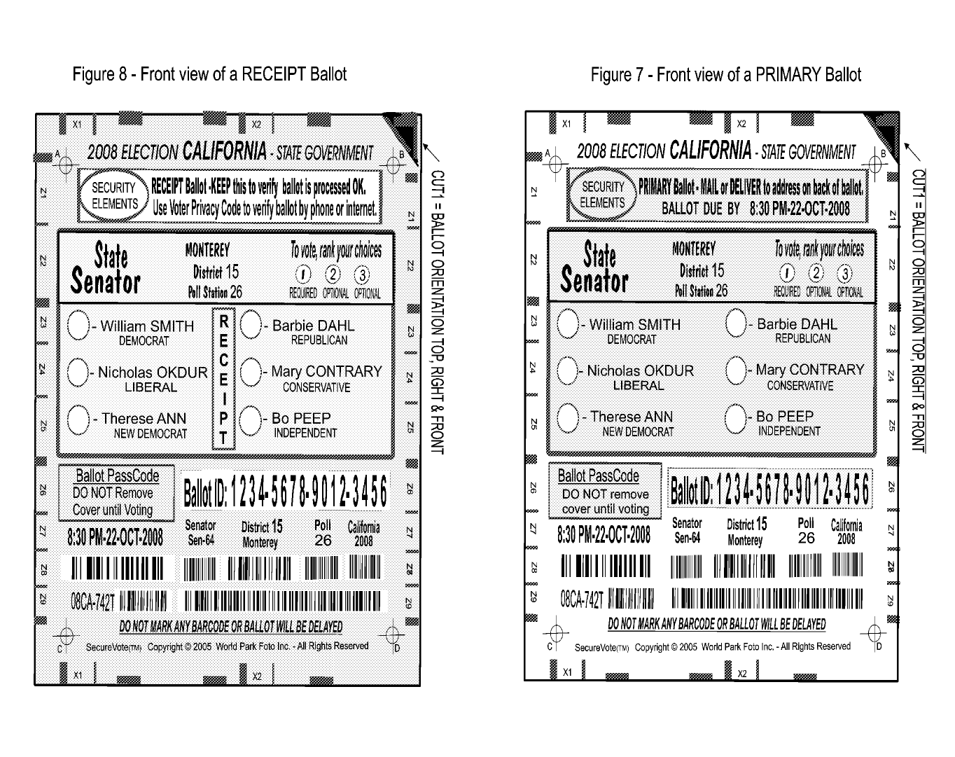

FIG. 7: a site plan view for the FRONT side of a second embodiment of a PRIMARY part of a Master Ballot of the invention;

FIG. 8: a site plan view for the FRONT side of a second embodiment of a RECEIPT part of a Master Ballot correlated to FIG. 7 of the invention.

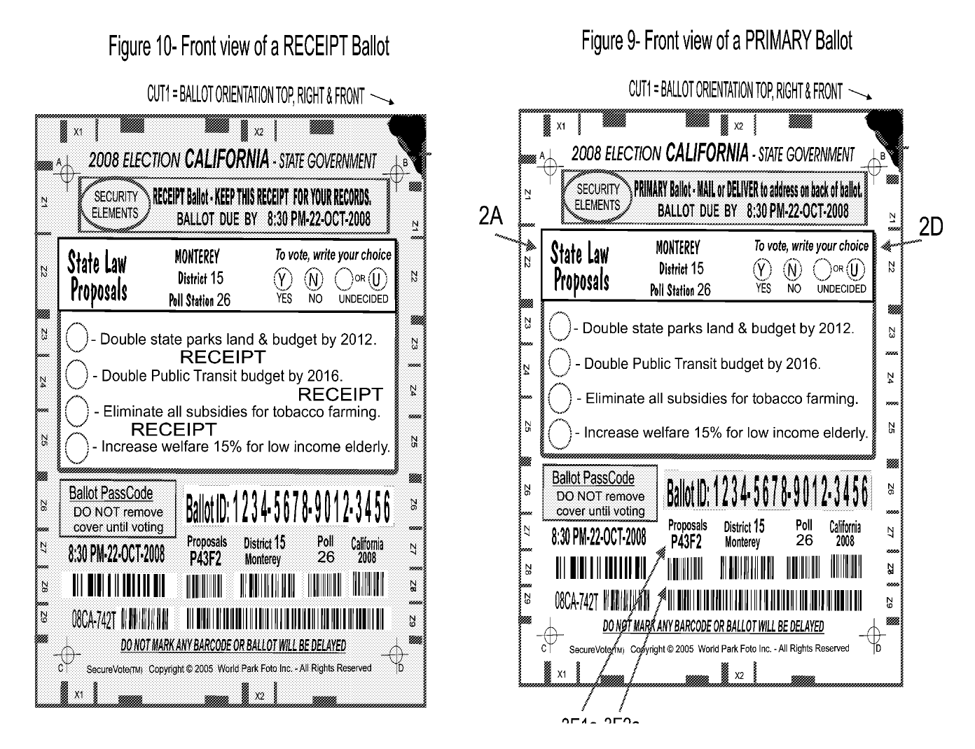

FIG. 9: a site plan view for the FRONT side of a third embodiment of a PRIMARY part of a Master Ballot of the invention;

FIG. 10: a site plan view for the FRONT side of a third embodiment of a RECEIPT part of a Master Ballot correlated to FIG. 9 of the invention.

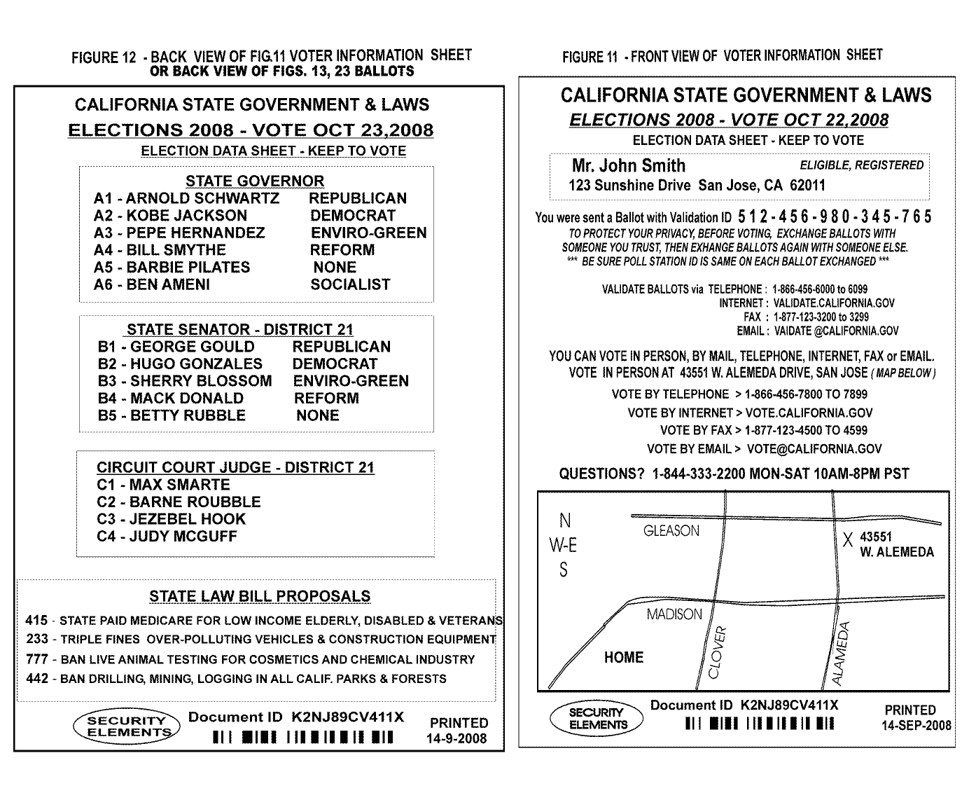

FIG. 11: is a site plan view of a first embodiment the Voter Ballot Information Sheet document of the invention.

FIG. 12: a site plan view for the BACK side of a first embodiment of a Voter Ballot Information Sheet, correlated to FIG. 11 of the invention.

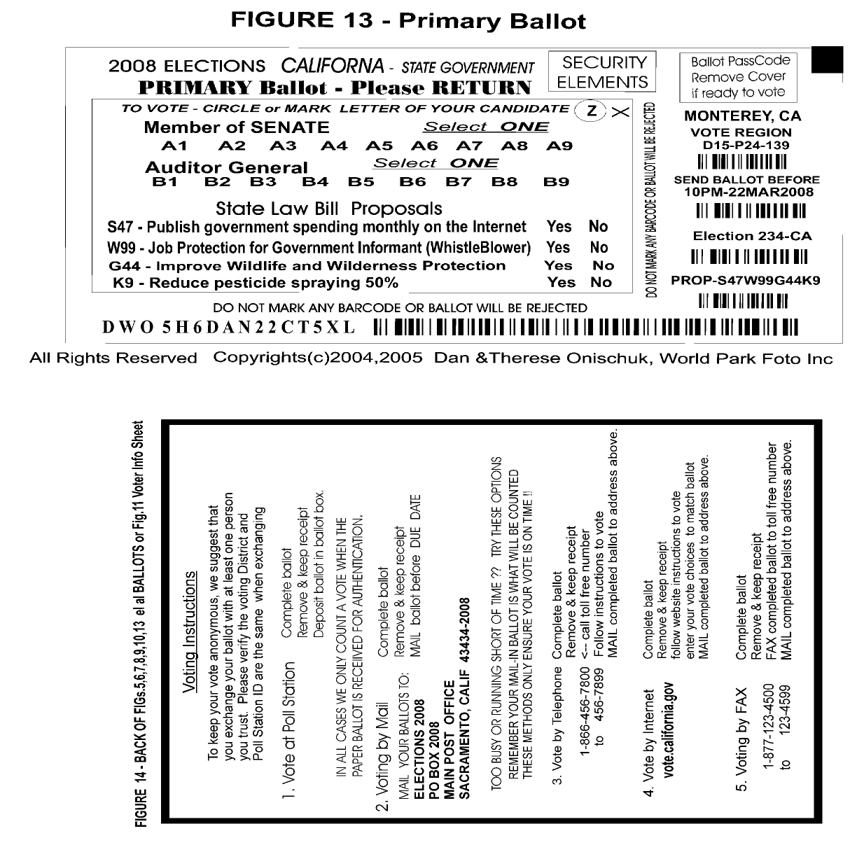

FIG. 13: a site plan view for the FRONT side of a fourth embodiment of a PRIMARY Ballot of the invention.

FIG. 14: a site plan view for the BACK side of a second embodiment of a Voter Instruction Sheet of the invention, and is correlated to FIG. 11, and with further modification, FIG. 14 may be correlated with FIGS. 5,6,7,8,9,10,13,18,19,20,21.

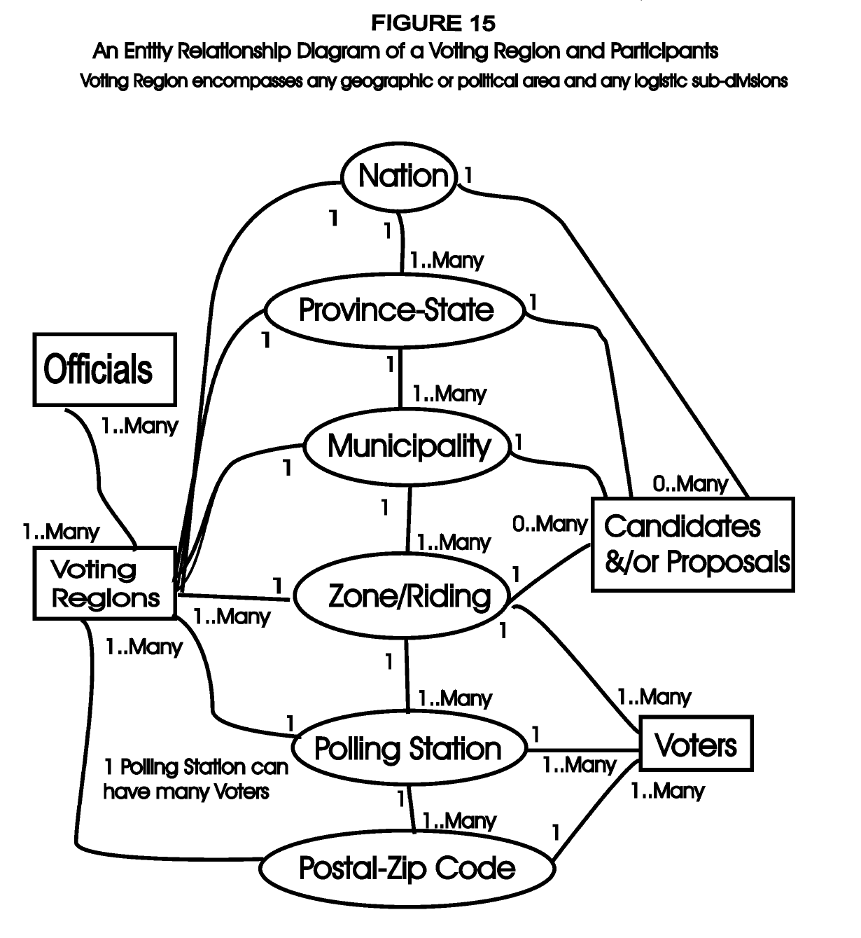

FIG. 15: is a site plan view of a first embodiment of an Entity Relation Diagram of Voting Regions and Participants of this invention.

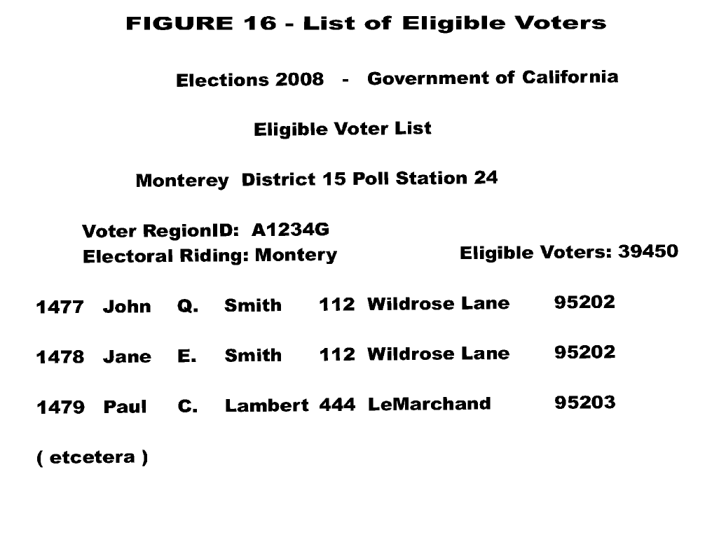

FIG. 16: is a site plan view of a first embodiment of a List of Eligible Voters, correlated with FIGS. 1,2,3,4 of this invention.

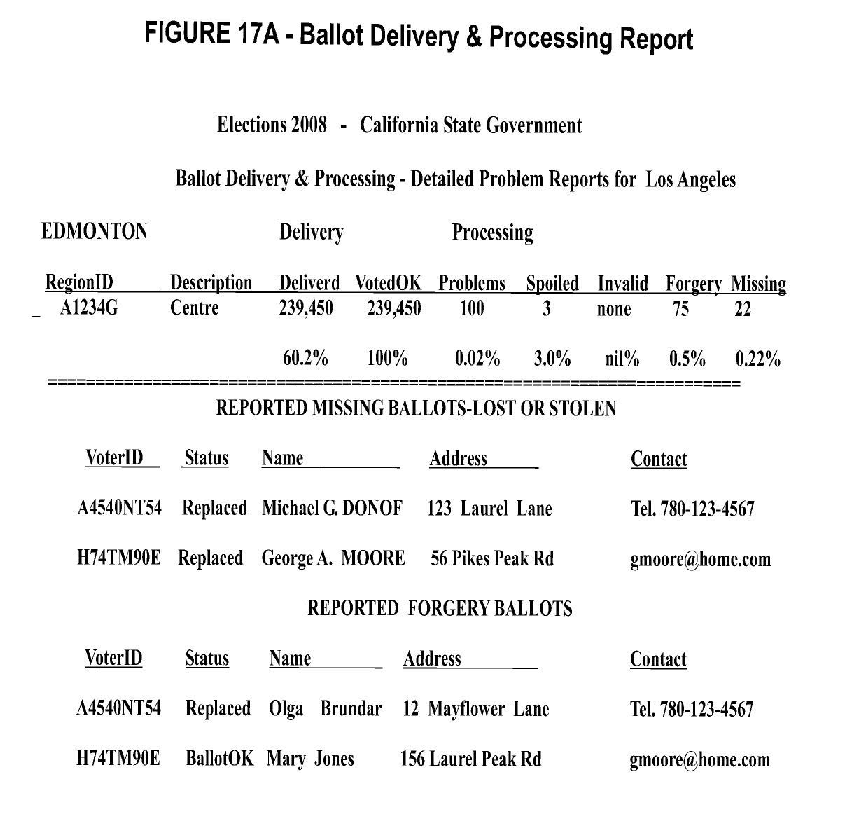

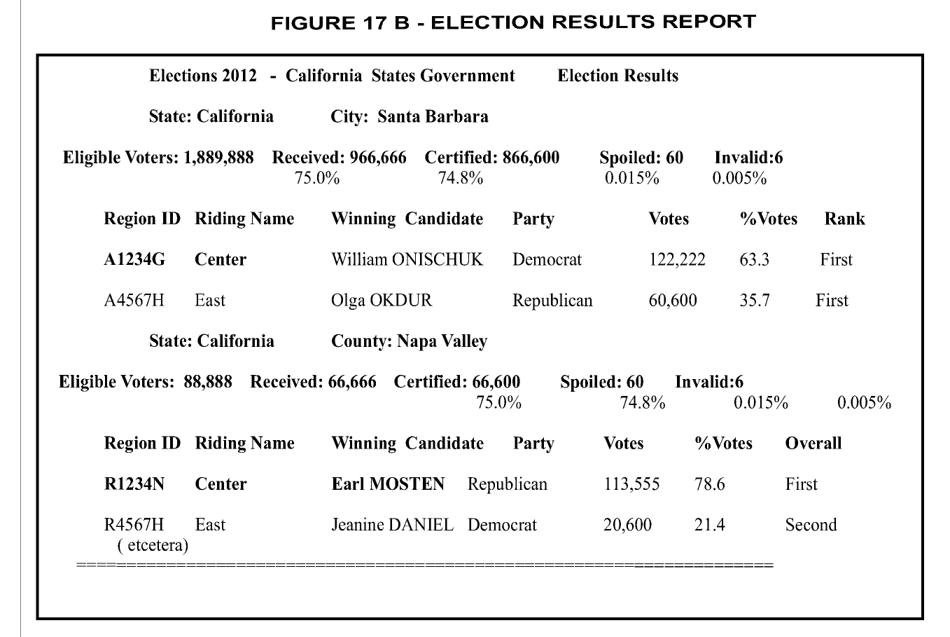

FIG. 17A: is a site plan view of a first embodiment of a Ballot Delivery & Processing Report which is correlated with FIGS. 5,6,7,8,9,10,13,18,19,20,21,23,24; and with further modification, FIG. 17A may be correlated with FIGS. 1,2,3,4,16,22.

FIG. 17B: is a site plan view of a first embodiment of a Elections Result Report which is correlated with FIGS. 5,6,7,8,9,10,13,18,19,20,21,23,24; and with further modification, FIG. 17A may be correlated with FIGS. 1,2,3,4,16,22.

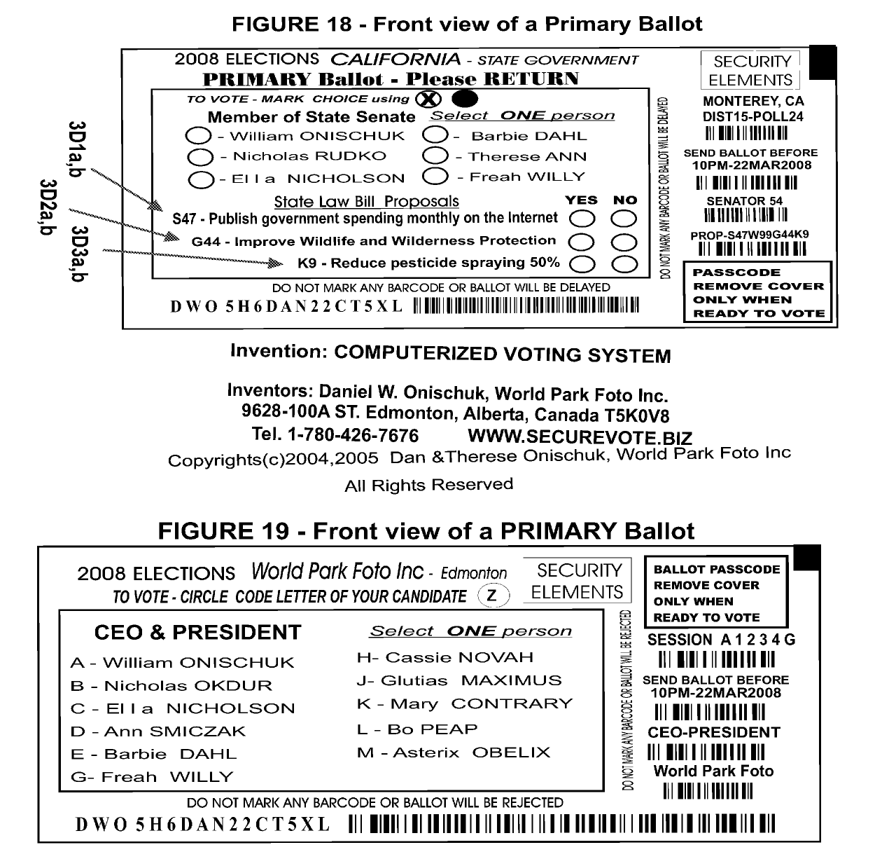

FIG. 18: a site plan view for the FRONT side of a sixth embodiment of a PRIMARY Ballot of the invention.

FIG. 19: a site plan view for the FRONT side of a seventh embodiment of a PRIMARY Ballot of the invention.

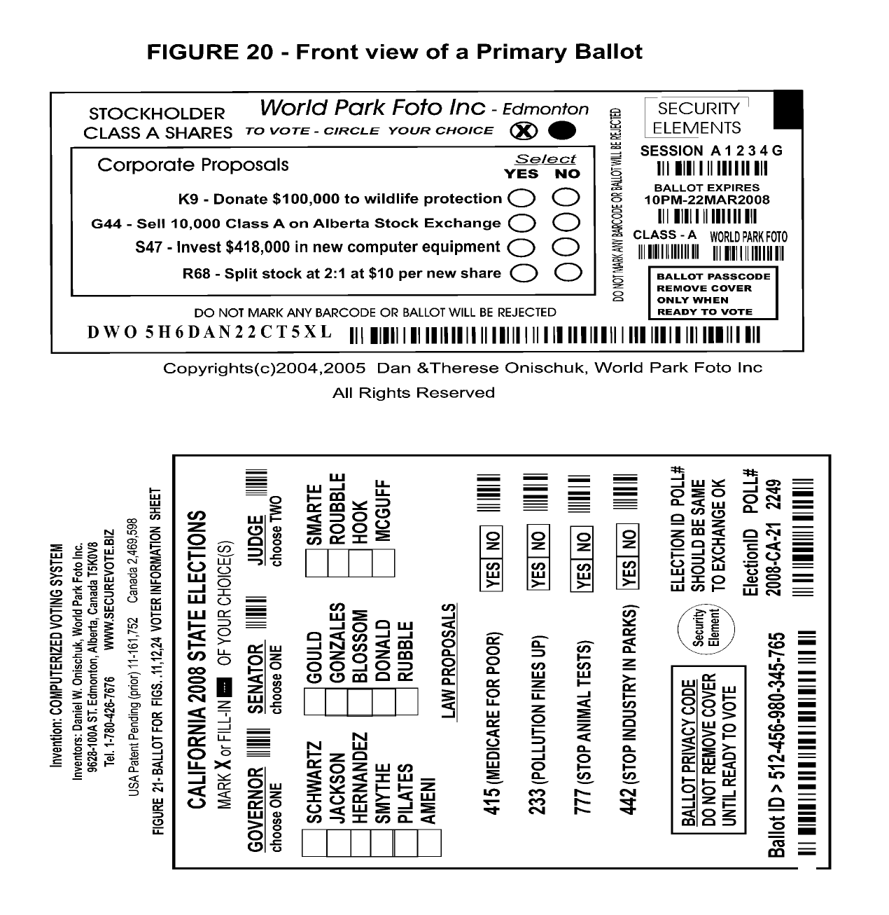

FIG. 20: a site plan view for the FRONT side of an eighth embodiment of a PRIMARY Ballot of the invention.

FIG. 21: a site plan view for the FRONT side of a ninth embodiment of a PRIMARY Ballot of the invention.

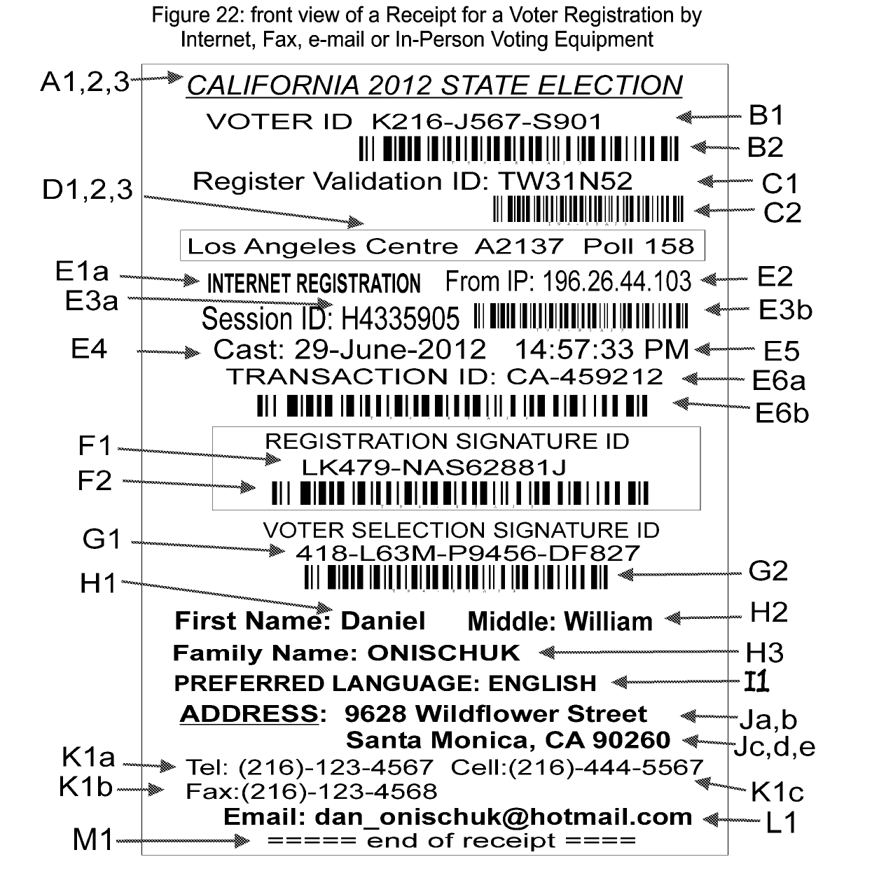

FIG. 22: a site plan view for the FRONT side of a first embodiment of a document for VOTER REGISTRATION RECEIPT directly correlated to FIGS. 1,2,3,4, and to FIG. 16.

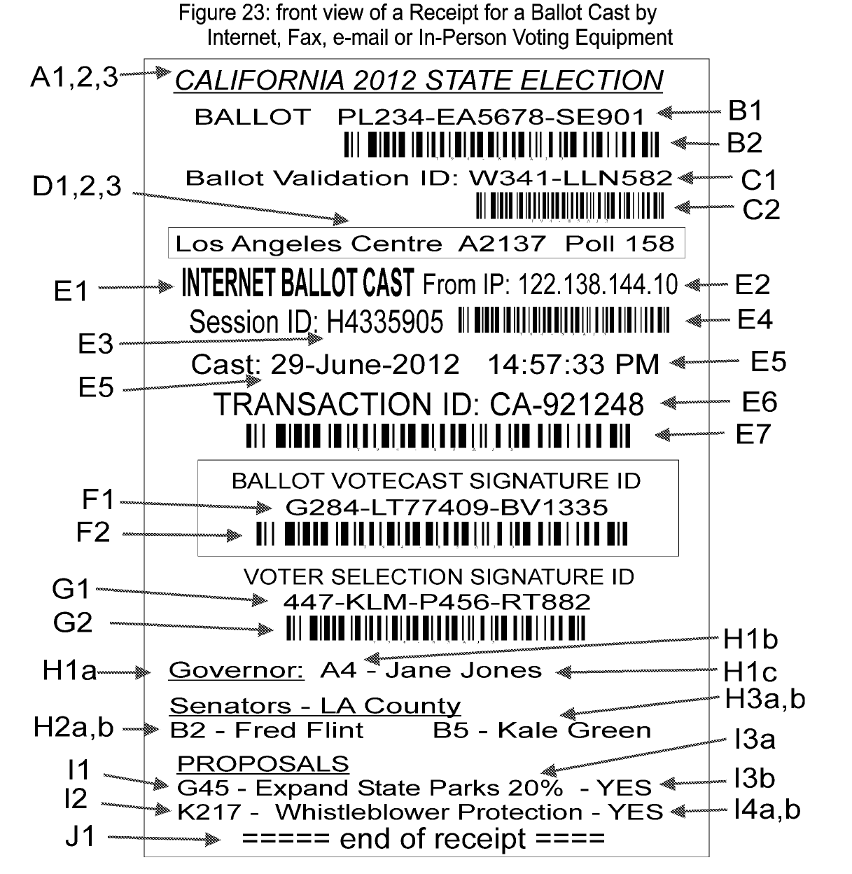

FIG. 23: a site plan view for the FRONT side of a first embodiment of a document for INTERNET VOTE RECEIPT of a PRIMARY Ballot directly correlated to Primary Ballots FIGS. 5,7,9,13,18,19,20,21 and is an alternative correlated to FIGS. 6,8,10,17A,17B

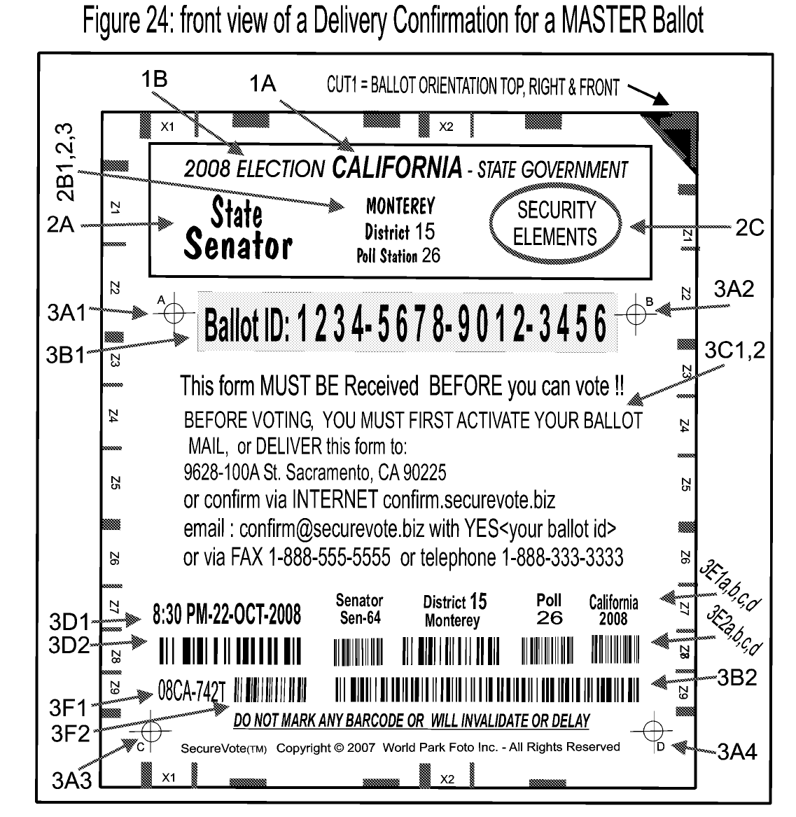

FIG. 24: a site plan view for the FRONT side of a first embodiment of a document for DELIVERY CONFIRMATION for a MASTER Ballot correlated to FIGS. 5-10,13,18-23; and with further modification, FIG. 24 may be correlated with FIGS. 1,2,3,4,16,22.

### DEFINITIONS OF TERMS

Official, or, Officials—refers to any number and any combination of: persons, devices, computer systems or communication networks appointed by the Hosts of the Voting Session to participate in order to facilitate any aspect of the Voting Session;

Voter, or, Voters, Eligible Voter, or, Eligible Voters—refers to any number of, persons, or, business entities, or any group of people or business entities, that are, or may be, entitled to participate in the Voting Session for the purpose of casting any number of ballots to select any number of candidates or proposals;

Voting Session—refers to a process or series of steps and methods for the at least one purpose: to elect at least one candidate, or, express at least one opinion regarding at least one proposal, or any combination of electing at least one candidate and expressing at least one opinion for at least one proposal;

Voting Region is used to describe the Scope of a Voting Session (FIG. 15). Voting Region is also used to refer to a variable group of attributes—Province/State, Municipality, Zone, Poll Station, Postal or Zip Code, which may be also used for document distribution planning, sorting, data segregation and storage.

Any number of Voting Region attributes may be visible on Ballots, Reports, Calculations, Tallies, Summaries, etcetera to meet the needs of a particular Voting Session.

### PREAMBLE

As the steps, means methods and processes described involve people and devices that are not perfect in design, function or operation, all aspects of this invention shall also include any steps, means, methods and processes of monitoring, acquiring, detecting, receiving, transmitting, verifying or correcting of any compromises, errors, duplicate data; and furthermore, any steps, means, methods and processes of monitoring, acquiring, detecting, receiving, transmitting, verifying effects of any corrections or other actions taken; All methods within the broad scope of data processing tasks may be applied to this invention; in particular this invention includes the means and methods of acquiring data from any remote or local data source, or any ballots of any type that conforms to the specifications of the Voting Session; furthermore these methods include:
A.) The steps of locating, detecting, reading, receiving, interpreting, translating, correcting, and transmitting any number of, and any combination of: symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing and any other physical structures associated directly with a ballot or a plurality of Master Ballots, Primary Ballots, Receipt Ballots, Voter Registration Forms, or Voter Registration Receipts or any related documents;
B.) The tasks of locating, reading, receiving, detecting, translating, correcting, interpreting and transmitting are performed by any combination of:
   i. at least one Official person;
   ii. any number of data acquisition devices;
   iii. any number of electronic, optical or biological computing devices or entities;
   iv. any number of communication networks;
   v. any number of other man-made device or plurality of devices;
C.) The methods of transmitting data to, and receiving data from, any number of humans, computers, devices, telephones, the Internet or any other communications networks; including the methods of translating human and device readable codes to modes, protocols or methods of communication and transmission;
D.) The methods of locating, receiving, detecting, interpreting, translating, reporting, and transmitting error free data, and the further steps of locating, receiving, detecting, interpreting, translating, reporting transmitting, and correcting compromised data, erroneous data, duplicate data and/or duplicate transmissions;

### DISCLOSURE OF INVENTION

The methods and steps involved in the assembly of a List of Eligible Voters is unique and the first of many improvements to existing patents within this scope of invention.
1.a) determination is made regarding the number of Potential Voters that could participate in the Voting Session, using data from reliable sources (such as census population data, immigration data, social security numbers or tax data for governments; stockholders or employee data for businesses; membership data for groups or organizations);
1.b) Official people or Official computers running software programs, determine which Research Voter records and which Potential Voter records meet the criteria of the Voting Session to be assigned the designation of Eligible Voter; furthermore, each voter meeting the criteria is designated an Eligible Voter record, and assigned a unique Eligible Voter ID; thereafter, assemble and organize at least one List of Eligible Voters of claim 1, based on Voting Session criteria, comprised of: at least, the names of the voter; and may also include their last known physical address for mail delivery; electronic address or any other method for delivery (such as a private fax machine number, or, forwarding contact address); furthermore, each List of Eligible Voters is assigned an Eligible Voter List Identifier (EVLID).
1.c) the EVLID is reviewed by Officials and all identical, duplicated records of Eligible Voters are removed so that only one instance of a unique Voter remains, so as to prevent multiple ballots being delivered to a single voter—or, in the case of proxy voters they are identified by the original voters name. In the case of stockholder shares, multiple ballots may be issued for each shareholder according to a predetermined number of shares threshold, or a single ballot may be issued having a weighting according to the percentage of shares held.
1.d) Officials publish each List of Eligible Voters—for example, on Internet website pages; and advertise the location and methods of accessing each List of Eligible Voters; which may include sending confirmation notices to each Eligible Voter on each List of Eligible Voters;
1.e) Officials provide means and opportunities to all Potential Voters and Eligible Voters to verify or amend each List of Eligible Voters—by telephone (voice or text message), computers via the Internet, by Mail (physical postal, courier, or electronic), facsimile (fax) (via internet, or telephone), or in-person.
2.a) Officials investigate each Potential Voter, Research Voter and Eligible Voter request for amendment and report the findings to Officials and the reporting Voter;
2.b) Officials amend any number of Lists of Eligible Voters of claim 1;
2.c) Officials and Voters independently verify amendments are accurately completed;
3.a) Officials prepare and publish any number of Voter Data Sheets which describes any combination of candidates, proposals, voting session rules, voting instructions, polling station maps, etc. This may also be repeated on the Officials website.
3.b) Official people or Official computers run software programs to design, produce and print specially designed MASTER Ballots; using the official language of the Voting Session; or, the predetermined, or, selected, preferred language of the Eligible Voter;
3.c) the number of MASTER Ballots printed or generated of the preceding step is very carefully regulated and monitored by Voting Session Officials so that the number of MASTER Ballots printed or electronically generated is correlated to the number of Eligible Voters; and optionally: an estimated number of Master Ballots to accommodate Lost, Stolen, Damaged, or Spoiled Ballots, plus an estimated number of new qualifying additions to each List of Eligible Voters used for the particular Voting Session;
3.d) before public distribution, any number of MASTER Ballots are tested whether it will pass tests to be VALID and AUTHENTIC with single and correlated group results noted;
3.e) Delivery Status identifier of each MASTER Ballot of prior step is designated as READY;
3.f) Activity Status identifier of each MASTER Ballot of prior step is set to be DORMANT;
3.g) Official people or Official computers run software programs to arrange delivery of at least one MASTER Ballots to each Eligible Voter on every Eligible Voter List of claim 1;
3.h) for each MASTER Ballot processed through the final steps for delivery, the value of the Delivery Status identifier changes from READY to SENT;
3.i) for each MASTER Ballot processed through the final steps for delivery, the value of the Activity Status identifier changes from DORMANT to ACTIVE; or alternatively, remains DORMANT until the MASTER Ballot recipient sends back (via mail, electronically or other method) confirmation of receipt of delivery of the MASTER Ballot.
4.a) Officials deliver, directly or via proxy, to Eligible Voters, at least one MASTER Ballot and any number of Voter Data Sheets, PRIMARY Ballot return envelopes, Delivery Confirmations (FIG. 24) (to acknowledge receipt of official forms and/or MASTER Ballots).
5.a.1) Any number of Voters (Applicants) or Officials (Applicants) deliver any number of PHONE, FAX, INTERNET, or INPERSON documents to any number of Officials;
5.a.2) Officials receive any number of PHONE, FAX, INTERNET, or INPERSON documents;
5.a.3) At least one Official accepts or rejects each received document based on the findings of tests applied to confirm the authenticity and validity of each document; for example, by verifying Security Element; verifying the Random Symbolic Identifiers, verifying Limits of Use; and any other checks while also applying practical techniques of error detection, reporting & correction (for data transmission & reception).
5.a.4) Officials may further accept or reject each received document based on Activity Status attribute of the ballot, whereby Officials accept ACTIVE/reject INACTIVE documents;
5.b.1) Any Eligible Voter or Official may obtain a REPLACEMENT document in exchange for any DAMAGED or SPOILED Voter Registration Form, Master Ballot or any other official document which has been deemed AUTHENTIC and VALID;
5.b.2) Any number of Officials record at least the names and address of each Applicant requesting a REPLACEMENT document; as well as the date and time of filing the request, as well as additional identification such as social security number, drivers license number, passport identifier to authenticate the Applicant's identity;
   a) if the Applicant claims to be an Eligible Voter, Official(s) search each current List of Eligible Voters for that Voting Session until a determination can be made;
   b) if the Applicant claims to be an Official of the current Voting Session, any other Official(s) search each List of Officials for that Voting Session to confirm;
5.c) Any Eligible Voter or Official may obtain a REPLACEMENT document (Voter Registration, Language Registration, MASTER ballot, etc.) in exchange for a LOST or STOLEN document which has been deemed ACTIVE—providing the Applicant first submits a valid Affidavit with valid identification, whereafter the receiving Official(s) CANCEL the correlated document (for example, by specifying the document RSID) and records the relevant details of each report—note that the CANCELLED document may still be processed to accumulate statistical or other information, but the CANCELLED document will be ignored in the final tally or before taking any effective action (thus underlining the importance of dealing with people you know & trust);
5.d) Officials amend all Voting Session records for ALL documents having IDENTICAL values for the Random Symbolic Identifier (RSID) so the Activity attribute value is CANCELLED;
5.e) Officials verify the LOST, SPOILED or DAMAGED Ballot Activity Status attribute is correct;
5.f) Officials select one MASTER Ballot, designated as a REPLACEMENT Ballot, for each Ballot that was CANCELLED in any of the preceding steps; whereby:
   5.f.1) each REPLACEMENT Ballot is identical to the CANCELLED ballot, except for at least one Random Symbolic Identifier of the REPLACEMENT Ballot being distinctly different from every Random Symbolic Identifier of the CANCELLED Ballot
   5.f.2) each REPLACEMENT Ballot is tested to be both VALID and AUTHENTIC;
   5.f.3) upon satisfying the preceding 5.f.1,2 each REPLACEMENT Ballot's Activity Status attribute value is set now to ACTIVE;
5.g) at least one Official delivers, or arranges delivery of, a one-for-one correlated number of REPLACEMENT Ballots to each successful Applicant; whereafter the Delivery Status attribute of each delivered REPLACEMENT Ballot becomes DELIVERED; and furthermore, each REPLACEMENT Ballot is now designated as a MASTER ballot;
5.h) any number of Officials record the quantity and type of REPLACEMENT documents delivered to each Applicant; and furthermore record the frequency that this occurs;
5.i) any number of Applicants receive any number of REPLACEMENT documents of the same type submitted as needing replacement;
6.) MASTER Ballot Exchange—this method is unique among registered US Patents, and provides a significant improvement in the arts pertinent to this scope of invention.
   6.a) Eligible Voters are entitled to exchange with someone they trust, any number of MASTER Ballots they possess for identical MASTER ballots that are authentic and valid for use as per the Limits of Use. Voters can authenticate the ballot in person, by telephone or Internet by verifying the Random Symbolic Identifier. Security Elements may also be used to determine whether the ballot is a forgery of truly authentic ballot.
   6.b) To protect privacy, Voters are instructed to swap the ballot the Voter received, at least once, with someone they trust for a similar ballot that is valid within the geographic-political boundary of the Voting Session. This random, private ballot exchange decouples the Ballot recipient from the Eligible Voter List of claim 1 that was used to deliver the unique BALLOT VOTING RSID to a specific person and address. This can be done a few times to increase the anonymity of the Voter. Furthermore, the privacy of the Voter is still enabled even if a Voter does not exchange MASTER Ballots, as the Voting Session Officials likely have no easy method to determine whether or not any MASTER Ballot was exchanged before being returned to them for tallying. The public RSID when queried will only reveal whether the ballot has been cast, without details. Ballot voting details are only revealed to the person who knows the Ballot private RSID which is hidden until casting a ballot, and optionally, the Voter's privately selected PIN—Personal Identification Number (e.g. bank ATM debit cards).
   Thus, Voter privacy is assured.
   However, a cautionary note—due to the possibility of a ballot being cancelled by a prankster or malicious party, it is important that the voter exchanges with a known person whom they can trust to be honest and responsible;
7.a) Each MASTER Ballot has at least two parts—a PRIMARY Ballot part and at least one RECEIPT Ballot part (e.g. FIG. 5 correlated FIG. 6, et al).
7.b.1) Each MASTER, PRIMARY and RECEIPT Ballot has at least one status attribute whereby each attribute value remains static and may be redefined in value by at least one Official;
7.b.2) The paper version of a MASTER, PRIMARY, or RECEIPT Ballot shall include any number of alignment marks and indices for orientation of optical, magnetic, electronic scanning device(s) so as to facilitate the accurate scanning of data on any reasonable ballot.
7.b.3) Each part of the MASTER Ballot, both the PRIMARY Ballot and any number of RECEIPT Ballots, share an identical, unique group of symbols as a correlating identifier. A unique feature of this invention is a Random Symbolic Identifier (RSID) as being the recommended unique correlating identifier, discussed in the later section 8.c.2.
7.c.1) the second ballot part of the MASTER Ballot is referred to as a RECEIPT Ballot; a unique feature of this invention is that each RECEIPT Ballot is manufactured so as to be easily and readily distinguishable from the PRIMARY Ballot, to the unaided human eye using any combination of methods (referred to in prior patent documentation) so as to distinguish the RECEIPT Ballot from the correlated PRIMARY Ballot;
8.) To understand the PRIMARY Ballot part of the Master Ballot of 7.a,b. refer to FIG. 5.
8.a) ballot header portion—this portion improves the invention of Kargel, et al by providing information to enable the voter to independently make clearly informed decisions regarding the ballot by providing information to the voter: as to the source of the ballot (FIG. 5 item 1A—ballot source); defining the scope of the ballot application (FIG. 5 item 1B—ballot purpose); clearly identifying the type of ballot (FIG. 5 item 1C—ballot type); instruction as to what to do with the completed ballot (FIG. 5 item 1D—ballot destination instruction).
8.b) Voting Portion—this portion improves the invention of Kargel, et al by providing vital information to enable the voter to independently make clearly informed decisions regarding the ballot selection options—by providing specific information as to the title of political position (FIG. 5 item 2A—candidate position description); specific instructions as to how many candidates to select (FIG. 5 item 2C—voting instructions); and information as to how to properly select the candidates of choice (FIG. 5 item 2D—candidate selection methods); as well as specific descriptions of the candidates to significantly reduce selection errors (FIG. 5 item 2E1—candidate names) and an optional description of the candidate political party affiliation (FIG. 5—item 2E2) and the correlated candidates selection area (FIG. 5, Item 2E3) for marking the candidate of choice (2D—candidate selection methods).
8.c) Security Elements portion (FIG. 5—item 3A) according to claim 6, such as, but not limited to: holograms, embedded threads, electronic circuitry are embedded or associated in some way as to be inextricably linked to the Ballot, for the purpose of authenticating the Ballot for the Voting Session. This portion also includes BALLOT VOTING RSID—unique among registered Patents, and provides a significant improvement in the arts of invention for this scope of application.

This invention was initially conceived without knowledge of any other prior invention, however with respect to Kargel, there is a common thread whereby each MASTER ballot, and the constituent parts comprising the PRIMARY Ballot, and any number of RECEIPT Ballots, share an identical identifier. Kargel is the acknowledged pioneer in this aspect of invention. However, this invention improves on Kargel by the use of a Random, Symbolic Identifier (RSID) (FIG. 5 item 3B1—BALLOT VOTING RSID in the form of a Random Symbolic Identifier) and a correlated RSID Barcode FIG. 5—item 3B2). The Random Symbolic Identifier (RSID) is comprised of a group of randomly selected symbols, which are arranged in a combination that is unique among all RSID's of a Voting Session. Thus each PRIMARY and RECEIPT Ballots that comprise a Master Ballot are uniquely identifiable among all ballots of a Voting Session, and each correlated ballot part shares the same unique BALLOT VOTING RSID used to validate and cast the ballot via a private BALLOT PASSCODE (another RSID).

The random identifier (RSID) prevents anyone with any ballot from fabricating a series of ballots, by incrementing or decrementing values in reference to any ballot(s) they possess.

A very significant improvement of this invention is to make the RSID to be extremely difficult to guess. Random Symbolic Identity (RSID)—Mathematics of Binary Encoding The purposes of the RSID is to enable verification by computer of the BALLOT VOTING RSIDentity as an authentication test of validity and to prevent counterfeiting of a multitude of ballots. Using at least one, and possibly two, or more, concatenated symbolic characters as a Random Symbolic ID (RSID) would provide unique identity security of every single ballot (depending on the number of ballots issued) for a single Voting Session.

Consider that ONE symbolic character can be represented by a unique combination of a sequence of eight (or more) computer binary digits ranging from 00000000 to 11111111. Each sequence of binary digits has a Base 10 counting system numeric equivalent value.

| ASCII characters | Binary code | Base 10 value |
|---|---|---|
| A | 01000001 | 65 |
| B | 01000010 | 66 |

Concatenating characters increases the number of binary digits that can be interpreted to represent larger binary and numeric (base 10) numbers, as well as for a plurality of counting base methods such as base 8 (octal), base 16 (hexadecimal), etcetera.

| ASCII characters | Binary code | Base 10 value |
|---|---|---|
| BA | 01000010 01000001 | 16961 |
| AB | 01000001 01000010 | 16706 |

Each unique concatenation is a unique combination of symbolic characters. The positional ordering sequence of the concatenated symbolic characters has a unique binary value and a correspondingly unique, equivalent numeric value that can be used to identify a specific sequence of concatenated symbolic characters.

Therefore each and every unique concatenation of symbolic characters also has a unique numeric value associated only with that specific combination of symbolic characters when using a consistent method of assigning each character symbol to one binary value. (Note: 1×10E3=1,000 1×10E4=10,000 the maximum value of the most significant digit of the binary number is calculated by 2EX where X=number of binary digits.

| ASCII | Binary | Total | |
|---|---|---|---|
| Characters | Digits | Binary Digits | Maximum Value |
| 16 | x 8 binary | 128 | 3 × 10E38 |
| 24 | x 8 binary | 192 | 6 × 10E57 |
| 32 | x 8 binary | 256 | 1 × 10E77 |

To understand how large these numbers are, consider that everything is made of atoms. Planet Earth has about 3.6×10E51 atoms; the entire Universe about 10E78 to 10E81 atoms.

reference note 1—http://mathforum.org/library/drmath/view/59178.html

reference note 2—http://pages.prodigy.net/jhonig/bignum/qauniver.html

How effective would a 16 character RSID (3×10E38) relative to the number of voters?What if we divided RSIDs among the entire human population of Earth: 7,000,000,000 3×10E38/7×10E9=4.28×10E28=42,800,000,000,000,000,000,000,000,000

That is how many unique RSID combinations would be available to EACH person on Earth. Guess which ONE they were assigned for a Ballot! A supercomputer capable of 4.28×10E15 guesses per second=4.28×10E28/4.28×10E15=1×10E13/365 days×24 hours×3600 seconds=317,000 YEARS to guess every RSID available to ONE person!!My estimate assumes 20× faster than todays supercomputers (circa November 2006) that can process 281×10E12 floating point ops/sec (http://www.top500.org/lists/2006/11). The actual number of symbols to use for this invention must be calculated, based on the number of voters anticipated, perception of security desired for making the RSID extremely difficult to guess, balanced with the data storage/retrieval speed, scanning error rate, computer processing and extra communication required—considering the total number of ballots issued, anticipated number of enquiries, replacements, verifications, authentications, amendments, calculations, publications, etc.

The resulting benefit and application of these mathematical facts and estimates is that any attempts to counterfeit any Ballots are futile, as without a valid RSID, a ballot is rejected by the Voting Session computers. There is no point trying to fake multiple copies of a known PRIMARY BALLOT VOTING RSID, as at most, only one RSID is considered in the vote records and tallies. When two or more ballots having an identical RSID are detected, the ballots prior and subsequent votes are nullified, then all ballots with the identical RSID are extracted and processed electronically and/or manually to inspect each Ballot composition and Security Elements for Authentication and Validation to certify which ONE ballot to tally for a Vote (or to reject all identical RSID ballots).

Therefore it is also absolutely vital that valid RSID's created by the Voting Session Officials be kept absolutely secret from all other Voters before and during the voting session. Any public RSID used for trial voting or information purposes should be disallowed in the actual voting records and tallies. To maintain secrecy, before and during the Voting Session, each RSID is known only to the Officials and who has a PRIMARY or RECEIPT Ballot.

The variety of Voting Sessions possible requires that the Ballot be considered as a variable data area, comprised of at least one portions, with each PRIMARY BALLOT portion also appearing in each RECEIPT Ballot. Each Ballot contains several data fields, which can be considered to be “data containers”, whereby any single “data container” may be displaying a combination of several distinct items of related information derived from various sources (e.g. database data or RSID search matrix data) provided by Officials, or, as data input in the form of information or selections made by each person Registering and/or Voting.

Ballot portions may be assigned for data areas such as, but not limited to: Header Portion, Security Portion, Voter Region Portion, Voter Selection Portion whose lengthy descriptions for this invention are noted in the following claims, such as, but not limited to claim 3. The data acquired from Registration & Voting Sessions is collected and processed to meet the accountability, certification, analysis and publishing (such as Internet webpages, internal processing reports e.g. FIG. 16,17A,17B) needs of any Registration &/or Voting Session of this invention, are described but not limited to, the claims and Drawings herein.

What is claimed is:

1. The steps and methods of Officials conducting a Voting Session, according to claims 1 to 19, whereby any number of Officials use the steps and methods of claim 9 to identify, research and assign any number of people or other legal entities to, at most, one type of Voters List (such as, but not limited to: Eligible Voters List (such as, but not limited to: FIG. 16), Proxy Voters List, Potential Voters List, or Ineligible Voters List); and the further step whereby each Eligible Voter, Proxy Voter, Potential Voter, or, Ineligible Voter is assigned one unique identification symbol or groups of symbols known as a Master Voter ID (MVID) to distinguish each person or legal entity from other voters or legal entities on the same Voters List or any other Voters List of this invention; and the further step whereby each type of Voters List is assigned a unique symbol or group of symbols to distinguish it from other types of Voter Lists of claim 1; and the further steps and methods of any number of Officials creating any number of duplicate copies of any number of each type of Voters Lists, and the further steps and methods of Officials processing any number of Voters Lists using the steps and methods of (but not limited to) claim 9; and the further steps and methods whereby each Voter is assigned a Master Voter Identifier (MVID) that is unique among all Voters and is also unique among all Voter Lists of the applicable Voting Session;

2. The further steps and methods of conducting a Voting Session according to claims 1 to 17, whereby any number of Officials correlate any number of unique Master Voter Identifiers (MVID's) of claims 1 and any number of Voters Lists of claim 1 to any number of Master Voter Registration Forms of this claim, whereby each Master Voter Registration form is comprised of two parts, whereby one part is a Primary Voter Registration form (FIG. 1) and the second part is comprised of any number of Receipt Voter Registration Forms (FIG. 2), such that each Primary and Receipt parts of each Master Voter Registration is assigned at least one unique identifier known as a Voter Registration ID (VRID) to distinguish each Master Voter Registration form (and its constituent parts) from all other Master Voter Registrations forms (and their constituent parts), and furthermore that for each Master Voter Registration form, the component Primary Voter Registration form and all Receipt Voter Registration forms (for the same Master Voter Registration form), contain identical Voter Registration information and are correlated to each other by sharing the same unique VRID identifier that is printed, embedded or linked to each part of the Master Voter Registration form; and the further steps and methods whereby each Master Voter Registration form (and each Primary and Receipt part) is comprised of (but not limited to)—at least one portion containing elements of voting information (such as, but not limited to—voting session name, voting session type, Voter Registration ID (VRID), assigned Voter Address identifier (VAID)) whereby each element of voting information is correlated to any number of scanning codes (such as but not limited to barcodes), and the further steps of assigning at least one portion for recording voter identification, at least one portion for recording the voters legal name, any number of portions for recording the voters signature, at least one portion for recording the date of Registration form completion; and the further steps and methods whereby each Receipt Registration form is manufactured so as to be easily distinguishable from the Primary Registration form using any combination of—additional word markings such as but not limited to the word RECEIPT, raised symbols (such as, but not limited to Braille codes), any number of different colors, different texture, or different materials, different physical, electronic, electromagnetic, or optical representation, or any other form of representation that differs from that which is used to manufacture the PRIMARY Registration form, which may include (but not limited to) creating, assigning, linking, attaching, embedding or any other steps and methods of (but not limited to) claim 9, for any number of, and, any combination of (but limited to)—symbolic codes (such as but not limited to RSIDs), physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing, embossing or any other physical structures associated uniquely and directly with the RECEIPT Registration form (FIG. 2) so as to distinguish each RECEIPT Registration form from every PRIMARY Registration forms; and the steps and methods of printing, assigning, linking, correlating or embedding any number of Security Elements of claim 6 (such as, but not limited to RSID, holograms) for each Registration Form (Master, Primary, or Receipt); and the further steps and methods for each Registration form of allocating identical portions for Voters or Officials to mark and record information comprising of, but not limited to—any number of personal identifiers, any number of printed names, any number of signatures, any number of date information, any number of location information; and the further steps and methods for each printed Master Voter Registration Forms of printing, attaching or embedding, any number of optical scanning markings, alignment markings or skew markings to ensure proper optical scanning, and the further steps and methods of consistently shaping, or cutting away, or marking at least one corner of each Master Voter Registration Form and thus to each Primary Voter Registration Forms and each Receipt Voter Registration Forms, so as to identify a consistent orientation (such as, but not limited to: front face in view and top edge uppermost) to assist in sorting, organizing, scanning, counting and any other human, mechanical, optical, electronic or hybrid processing or other processing according to claim 9 of any number of Voter Registration Forms (Master, Primary or Receipt) and any number of Voter Registration Containers; and the further steps and methods for each electronic Voter Registration forms (Master, Primary and Receipt) of processing according to (but not limited to) claim 9 to ensure data record quality requirements such as, but not limited to: accuracy, integrity, security and longevity; and the further steps and methods of applying the steps and methods of this claim to any number of other items such as, but not limited to: forms, documents, ballots containers, in any format (such as but not limited to: electronic file, or, printed on paper), such as, but not limited to Master Voter Language Forms and the constituent components, such that, but not limited to: whereby any number of Officials correlate any number of unique Master Voter Identifiers (MVID's) and any number of Voters Lists of claim 1 to any number of Master Voter Language forms of this claim, or, any number of Master Voter Registrations of claim 2 to any number of Master Voter Language Forms of this claim; and the further steps and methods of processing according to claim 9, any number of Master Voter Language forms, any number of Primary Voter Language forms, any number of Receipt Voter Language forms, whereby each Master Voter Language form is comprised of two parts, whereby one part is a Primary Voter Language form (FIG. 3) and the second part is comprised of any number of Voter Language Receipt forms (FIG. 4), such that each Primary and Receipt parts of each Master Voter Language form is assigned at least one unique identifier known as the Voter Language ID (VLID) to distinguish the Master Voter Language forms (and its constituent parts) from all other Master Voter Language forms (and their constituent parts), and furthermore that for each Master Voter Language form, the component Primary Voter Language form and all Receipt Voter Language forms (for the same Master Voter Language form), are nearly identical and are correlated to each other by sharing the same unique MLID identifier that is printed, embedded or linked to each part of the Master Voter Language form; the steps and methods of printing, assigning, linking, correlating or embedding any number of Security Elements of claim 6 (such as, but not limited to RSID, holograms) for each Language form (Master, Primary, or Receipt); and the further steps whereby at least one portion containing elements of voting information, correlated to any number of barcodes or other optical scanning markings, at least one portion containing additional information, and the further steps and methods whereby each Receipt Language form is manufactured so as to be easily distinguishable from the Primary Language form using any combination of—additional word markings such as but not limited to the word RECEIPT, raised symbols (such as, but not limited to Braille codes), any number of different colors, different texture, or different materials, different physical, electronic, electromagnetic, or optical representation, or any other form of representation that differs from that which is used to manufacture the PRIMARY Language form, which may include linking, attaching or embedding any number and combination of (but not limited to)—Security Elements of claim 6, and any number of other steps, methods, properties, materials or representational forms described in claim 2 that are used to differentiate Primary Registrations from Receipt Registrations shall also be applicable to RECEIPT Language Forms so as to distinguish each RECEIPT Language Form from every PRIMARY Language Forms; and the further steps and methods of this claim that were attributed to Voter Registrations to be applied for each Language Form, any other object such as, but not limited to documents, forms, reports, containers, electronic files, physical objects; and (d) the further steps and methods for the any version of any number of MASTER, PRIMARY, or RECEIPT Ballots whereby any each shall include any number of but not limited to: alignment marks, graphics, electronic encoding, magnetic fields, and/or any form of index identifiers for orientation of optical, magnetic, electronic scanning device(s) so as to facilitate the accurate scanning of data on any ballot in reasonable condition; and (e) the further steps and methods for printed ballots of including such as, but not limited to) a darkened, highlighted or cut-away corner so as to enable identical orientation of ballots for faster preparation for scanning (such as but not limited to: FIG. 5—cut1 note, see also FIGS. 13,18,19,20—black mark top right corner); whereby any number of (but not limited to) the aforementioned steps and methods are used so as to enable rapid automated optical scanning using high speed scanning devices, computers, using the steps and methods according to (but not limited to) claim 9 of this invention; and the further steps whereby the aforementioned steps and methods are applied to any number of other items of this invention, such as, but not limited to: Voter Information Sheets (such as, but not limited to: FIG. 16, 17A, 17B).

3. The steps and methods of conducting a Voting Session according to claims 1 to 17 whereby any number of Officials correlate any number of unique Master Voter Identifiers (MVID's) and any number of Voters Lists of claim 1 to any number of Master Voter Ballots of this claim, or, any number of Master Voter Registrations of claim 2 to any number of Master Voter Ballots of this claim; and the further steps and methods such as, but not limited to claim 9 for the steps and methods of, but not limited to: defining, designing, verifying, correlating, amending, certifying, preparing, organizing, sorting, assembling, recording, storing, printing, distributing, receiving, scanning, correlating, validating, authenticating, publishing and otherwise processing any number of Master Ballots, any number of Primary Ballots, any number of Receipt Ballots, whereby each Master Ballot is comprised of parts, whereby one part is the Primary Ballot (FIG. 5,7,9,13,18-21) and any other parts are comprised of at least one Receipt Ballot (FIG. 6,8,10), such that each Primary and Receipt parts of each Master Ballot are assigned at least one unique PUBLIC Ballot Verification Random Symbolic Identifier (BALLOT VOTING RSID), which is prominently visible on the Master Ballot correlated Primary part and correlated Receipt parts so as to distinguish that Master Ballot (and its component parts) from all other Master Ballots (and their component parts) and furthermore that for each Master Ballot component Primary Ballot and all component Receipt Ballots are all correlated to each other by sharing the same unique BALLOT VOTING RSID that is printed, embedded or linked or otherwise displayed prominently on each Primary Ballot and Receipt Ballot part of the Master Ballot; and the further steps whereby each Receipt Ballot is manufactured so as to be easily distinguishable from the Primary Ballot to the using any combination of—additional word markings (such as but not limited to the word RECEIPT), raised symbols (such as, but not limited to Braille codes), any number of different colors, different texture, or different materials, different physical, electronic, electromagnetic, or optical representation, or any other form of representation that differs from that which is used to manufacture the PRIMARY Ballot, which may include any combination of (but limited to)—any number of Security Elements of claim 6, and the further step whereby any number of other steps, methods, properties, materials or representational forms described in claim 2 or any other claims of this invention, may also be applied to differentiate every correlated and non-correlated PRIMARY BALLOTS from every RECEIPT BALLOTS; and the further steps and methods for every MASTER BALLOT, each PRIMARY BALLOT and each RECEIPT BALLOT component are subdivided and have allocated BALLOT PORTIONS for Officials to mark and record information, and for Voters to mark or otherwise make selections, such that every subdivided BALLOT PORTIONS may consist of portions such as, but not limited to:
(a) Ballot Header portion—this portion provides information to enable the voter to independently make clearly informed decisions regarding the ballot such as, but not limited to:
(i) the source of the ballot (FIG. 5 item 1A, optionally, FIG. 5—3E1d);
(ii) a unique Voting Session Identifier (FIG. 5—3F1) which are correlated to any number of scannable barcodes, or other symbolic codes, (such as but not limited to: 3F1 to 3F2) to facilitate automated processing in accord with, but not limited to claim 9;
(iii) defining the scope of the ballot application (FIG. 5 items 1A,1B,3E1d);
(iv) identifying the type of ballot (FIG. 5 item 1C);
(v) instruction for completed ballot (FIG. 5 item 1D) completion which are correlated to any number of scannable barcodes, or other symbolic codes, such as but not limited to: FIG. 5—items 3F1, 3F2 to facilitate automated processing in accord with (but not limited to) claim 9;
(b) Vote Selection portion—this portion provides information to enable the voter to independently make clearly informed decisions regarding the ballot selection options by providing specific information such as (but not limited to):
(i) any number of Titles of Political Position (FIG. 5 item 2A candidate position description) which may optionally be repeated ad also include a Candidate Position Identifier (FIG. 5—3E1a) which is further correlated to any number of scannable barcodes (FIG. 5—3E2a) or other symbolic identifiers; and/or any number of Title of Issues (FIG. 9 item 2A) which may optionally include a Proposal Ballot Identifier (FIG. 9—3E1a) that is correlated to any number of barcodes (FIG. 9—3E2a) or other symbolic identifiers;
(ii) at least one description of the Voting Region the ballot is correlated to, such as, but not limited to: name of the voting region (FIG. 5—2B1) the Voting Region ID (FIG. 5—2B2) and Poll Stations ID (FIG. 5—2B3), that may optionally be repeated (FIG. 5—3E1b,c) and further correlated to scannable barcodes (FIG. 5—3E2b,c) or other symbolic codes to facilitate automated processing according to, but not limited to claim 9;
(iii) any number of specific instructions as to how many candidates to select (FIG. 5 item 2C) and/or Issues/Proposals (FIG. 9);
(iv) any number of instructions on to how to properly select the candidates of choice (FIG. 5 item 2D) or issue proposals (FIG. 9—Item 2D);
(v) any number of specific descriptions of the candidates names to significantly reduce Voter selection errors (FIG. 5—item 2E1) and/or any number of Issue/Proposal ID codes (FIG. 18—item 3D1a,2a,3a also FIG. 20);
(vi) any number of descriptions of the Political Party affiliation for each candidate appearing on the ballot (FIG. 5—item 2E2); and/or any number of descriptions of Issues/Proposals (FIG. 9,18—item 3D1b,2b,3b also FIG. 20);
(c) Security Elements portion (FIG. 5—item 3A) according to claims 6, 14,15 which are comprised of any number of elements such as, but not limited to:
(i) any number of holograms, embedded threads, electronic circuitry, or other devices according to claim 6, embedded or associated as to be inextricably linked to any number of Ballots, Registration forms or any other documents, for the purpose of authenticating the Ballots, Registration forms and documents for the Voting Session;
(ii) any number of BALLOT VOTING RSIDs—refer FIG. 5, item 3B1 which may be, but is not limited to: Random Symbolic Identifier, or, Sequential Symbolic Identifier, or, Group Pattern Sequential ID, or Group Pattern Random Sequential ID, which are ALL interchangeably referred to in this version of the patent description as an RSID; such that the BALLOT VOTING RSID is comprised of a unique group of symbols which are arranged in a combination that is unique among all BALLOT VOTING RSID's of each Voting Session, such that each PRIMARY and RECEIPT Ballots that comprise a Master Ballot are uniquely identifiable among all PRIMARY and RECEIPT Ballots of a Voting Session, and for example, is described in (but not limited to) FIG. 5—item 3B1 which is further encoded and correlated to a unique barcode symbol (such as but not limited to) FIG. 5—item 3B2; and the further step whereby at least one BALLOT VOTING RSID is comprised of numbers, symbols or a group of numbers and symbols, randomly generated to be of a length, content, and construction as to be extremely difficult to guess by chance or to determine manually or when assisted by any number of computers running software programs, or other devices for such a purpose; and the further steps and methods whereby any number of unique codes (such as, but not limited to—a binary digital numeric code, a binary digital ASCII code) are consistently created, assigned, associated, stored, retrieved, communicated and processed according to claim 9, for each unique group combination of numbers, symbols, or groups of numbers and symbols that collectively form the BALLOT VOTING RSID;
(iii) any number of BALLOT PASSCODEs whereby each is comprised of numbers, symbols or a group of numbers and symbols so as to be of a constructed length and content that is extremely difficult to guess or determine, such that each BALLOT PASSCODE is randomly generated by Officials using computers running software programs; and the further step whereby at most, one single BALLOT PASSCODE is correlated to each BALLOT VOTING RSID; and the further steps of immutably recording and storing the BALLOT PASSCODE in correlation with the associated BALLOT VOTING RSID; and the further steps and methods whereby any number of BALLOT PASSCODEs are consistently created, assigned, associated, stored, retrieved, communicated and processed according to claim 9; and the further steps and methods whereby the BALLOT PASSCODE is hidden from viewing by a removable covering or temporarily sealed container such that the only way for the BALLOT PASSCODE to be viewed will automatically create evidence of having been revealed; whereby the BALLOT PASSCODE may be delivered separately or optionally hidden from view when integral with the Ballot or document (FIG. 5, item 3C1) so as to enable Ballot Validation without revealing how to enable the Ballot for Voting or access to view selections; whereby the BALLOT PASSCODE is constructed to be sufficiently different in length and composition so as to not be confused with the BALLOT VOTING RSID and any other RSID, ID or SIGNATURE ID of this invention; and the steps that a BALLOT PASSCODE limits access to the correlated BALLOT VOTING RSID Vote Selection portion of this claim, by requiring the correct combination of BALLOT VOTING RSID and correlated BALLOT PASSCODE to be submitted by the Voter to obtain authorization from Official computers running software programs, before a Voter can mark any number of Vote Selections; and the further step whereby after a Ballot is completed and cast for processing, each BALLOT PASSCODE can only be used to enable viewing of the entire BALLOT VOTING RSID and the entire eVoting Receipt (FIG. 23);
(iv) any number of VOTER PINs whereby the Voter PIN is comprised of numbers, symbols or a group of numbers and symbols, and is manually created and entered by the Voter so as to further secure and personalize their ballot information; and furthermore that the Voter PIN be manually constructed by the Voter (with guidance instructions and optional methods from Officials), so as to be sufficiently different in length and composition so as not to be confused with a BALLOT VOTING RSID or BALLOT PASSCODE; and the further steps and methods whereby any number of Voter PINs are consistently correlated, stored, retrieved, communicated and processed according to claim 9 for each correlated BALLOT VOTING RSID; and the further step of allowing only one single, most recently entered VOTER PIN to be active and valid for each correlated BALLOT VOTING RSID; and the steps and methods whereby any number of VOTER PINs created by any number of Voters is used to replace any number of BALLOT PASSCODEs; and the further optional step of enabling the most recent, valid VOTER PIN to be substituted for the BALLOT PASSCODE of the correlated BALLOT VOTING RSID; and the step that a VOTER PIN limits access to enable anyone to only view the entire CAST BALLOT information and the entire eVoting Receipt (FIG. 23) for the correlated BALLOT VOTING RSID—by requiring the correct combination of BALLOT VOTING RSID and correlated VOTER PIN to be submitted by the Voter to obtain authorization from Official computers running software programs and thereby enable aforementioned viewing;
(v) and the further steps and methods for each Primary Ballot, each Receipt Ballot and each BALLOT PASSCODE of each Master Ballot; the steps and methods of printing, assigning, linking, correlating or embedding any number of Security Elements of claims 6,14,15 (such as, but not limited to BALLOT VOTING RSID, BALLOT PASSCODE, hologram(s)) for each Ballot Master, Primary, Receipt) as well as enacting any number of BALLOT PASSCODE, VOTER PIN and BALLOT VOTING RSID authentication challenges, layer of data encryption and security according, but not limited to claims 9,14,15 of this invention;
(d) Limits of Use portion—Expiry/Due Time (FIG. 5—1C & 3D1a) and Expiry/Due Date (FIG. 1D & 3D1b) are the final time and/or date when the Ballot is no longer useable for the Voting Session, and thus must be received by Officials on or before at least one Expiry Date & at most one Expiry Time in order to be successfully processed for certification and tallying;
(e) at least one Voting Region portion, comprised of, but not limited to:
(i) at least one Voting Region ID (FIG. 5—item 3E1b,c,d—whereby items 3E2b,c,d are barcodes correlated to the values of items 3E1b,c,d and thus 2B1,2,3) is a unique identifier or group of identifiers used to further define the scope of application of the ballot such that it is correlated to (but not limited to) a geographic area, or, a subset of a group of people or legally recognized entities, etcetera;
(ii) at least one Voting Region Names and Descriptions (FIG. 5—item 1A,1B, 2B1,2B2) to ease human interpretation for voting, ballot exchanges and other processing of ballots, including data fields such as, but not limited to:
(iii) at least one Voting Session & Scope Identifier (FIG. 5—items 1A, 1B, 2A, 3E1d such that the voting session official host identifier (HostID—FIG. 5 item 3E1d, and 3E2d is a barcode whose value is correlated to the value of FIG. 5—item 3E1d and vice versa) is a unique identifier used to initially determine the scope whereby all Voting Session ballots are to be applied for use; and is assigned to at least one organization, government, business or other entities;
(iv) at least one Region-Zone Name Description (FIG. 5—item 2B1, 3E1b—bottom) further correlated to any number of items such as, but not limited to:
1) at least one Region-Zone Identifier (FIG. 5—item 2B2,3E1b—top)
2) at least one Polling Station identifier (FIG. 5—item 2B3,3E1c) that is correlated to FIG. 5—item 2B2, which serves to identify at least one sub-region within a Region-Zone ID and is useful to assist interpreting voter responses within a larger Zone or Region ID; and the alternative step of using an integral Region-Polling Station ID (FIG. 18, below top right corner) whereby concatenated values of the Region-Zone ID, Poll Station ID, etc, are encoded as one single correlated barcode, or alternatively, displayed as adjacent, but separate barcodes; and the further steps whereby FIG. 5—item 3E2c is a barcode correlated to the value of FIG. 5—item 3E1c).
(v) any number of Candidate Duty Identifiers (FIG. 5—item 2A, 3E1a) and any number of Proposal Identifiers (FIG. 13,18 just above bottom right corner); or any number of both Candidates and Proposals Identifiers; whereby in the case of an election candidate, this DutyID identifier (FIG. 5—item 3E1a, such that item 3E2a is a barcode correlated to the value of item 3E1a and vice versa), is used to encode the description of the political position the candidate seeks election to; and whereby in the case of a ballot Proposal Identifier (FIG. 13,20, 18—item 3D1a,2a,3a), the Proposal ID is used to uniquely encode each description, and to link all documents with similar Proposal ID codes, so as to enables local customization of Proposals within a sub-region of a larger region;
vi) any number of Voting Method instructions (FIG. 5—items 2C, 2D);
vii) any number of BALLOT PASSCODEs (FIG. 5—item 3C1) whereby they are covered or separately distributed and should not be revealed until ready to vote;
viii) at most one Time-Date Portion comprised of at most one Due Time (a.k.a. Expiry Time) (FIG. 5—item 3D1a) and at most one Due Date (a.k.a. Expiry Date) (FIG. 5—item 3D1b) whereby when those values are exceeded, the Ballot is no longer useable such that (but not limited to):
1) Due Time (FIG. 5 item 3D1a—duetime) describes the latest time the ballot is required to be delivered to the designated receiver(s) for the Voting Session, and may also include regional time zone information such as MST, as well as appropriate notice of Daylight Savings Time considerations (e.g. DST—active).
2) Due Date (FIG. 5—item 3D1b—duedate) describes the latest date the ballot is required to be delivered to the designated receiver(s) for the Voting Session; and may also include notations regarding calendar type (Julian, Gregorian) as well as notes of variances due to holidays or leap days (e.g. February 29—active).
3) at least one barcode for Due Date and Due Time (FIG. 5—item 3D2) can be a concatenation of distinct barcodes for Due Date & Due Time; or can be a combined expressions of the Due Date & Due Time;
(f) any number of additional data fields and correlated barcodes to ease ballot exchanges, ballot distribution, ballot storage, ballot or data retrieval, reports & analysis, sorting, grouping, segregate data, collate documents, cost accounting, tracking or any other steps or methods of processing according to claims 1-17;
(g) and the further steps and methods whereby any number of removable coverings may be applied to the front of a primary ballot or any other document such that the cover obscures non-essential information and also reveals necessary information;
(h) and the further steps for the purpose of expediting document sorting, scanning or any other processing where a common orientation of documents is desired, the further steps to enable identical orientation of any number of documents in a collection or group, including methods such as, but not limited to: a darkened corner, (FIG. 13,18,19,20 top right corner), or, a cut-away corner (such as, but not limited to FIG. 5—cut1); and the further step of rotating and flipping over any number of documents in a collection or group so that each documents darkened mark or cut-away area are in the same position relative to a consistent reference document or spatial reference position;
(i) and the further steps and methods for the any version of any number of MASTER, PRIMARY, or RECEIPT Ballots (or any other objects such as but not limited to: documents, forms or containers) whereby each shall include any number of but not limited to: alignment marks, graphics, electronic encoding, magnetic fields, and/or any form of index identifiers for orientation of optical, magnetic, electronic scanning device(s) so as to facilitate the accurate scanning of data on any ballot in reasonable condition; and the further step to include a warning message (FIG. 5—item 3G) to reduce scanning errors;
j) and the further steps and methods whereby any number of (but not limited to) the aforementioned steps and methods are used so as to enable rapid automated optical scanning using high speed scanning devices, computers, using steps and methods according to (but not limited to) claim 9; and the further steps and methods generally whereby any number of data fields symbolic characters are scanned and compared to the data derived from their respective correlated barcode (such as, but not limited to: each BALLOT VOTING RSID characters are scanned and compared to the value derived from the correlated barcode) using computers and optical or magnetic field scanners and computers employing software programs and the steps and methods of, but not limited to claims 9,14,15; and the further steps and methods of detecting and reporting any number of scanning errors of any type according to, but not limited to claims 9,14,15; and the further steps and methods of rescanning any number of reported error data fields, symbols and/or barcodes according to, but not limited to claims 9,14,15;
(k) and the further steps and methods of claims 1 to 17 of this invention;

4. The steps and methods of conducting a Voting Session according to claims 1 to 17 whereby any number of Officials use at least one Voter List of claim 1 to determine, assign, sort, organize, package, deliver or transmit or otherwise process according to, (but not limited to) claim 9, any number of Master Ballots of claim 2, or, any number of Master Voter Registration Applications of claim 2, or, any number of Master Voter Language forms of claim 2, or any number of other related documents of information or instruction, any number of self-addressed envelopes, any number of postage pre-paid stamped, self-addressed envelopes, and then modifying any number of attributes associated with each Master Ballot or Master Voter Registration Application using computers running programs, along with any number of other steps and methods of (but not limited to) claim 9, as well as permanently recording the issuing of each Master Ballot of claim 2 that is distributed to each Voter on each List of Eligible Voters of claim 1, or each Master Voter Registration Application of claim 2 sent to each Potential Voter on each List of Potential Voters of claim 1 and each Eligible Voter on each List of Eligible Voters of claim 1, or, each Master Voter Language form of claim 2 sent to each Potential Voter on each List of Potential Voters of claim 1 and each Eligible Voter on each List of Eligible Voters of claim 1, and then subsequently modifying and recording any number of attributes associated with each Master Ballot, Voter Registration Form, Voter Language Form, Master Ballot Container, or any other documents or containers sent to each Eligible Voter and each Potential Voter.

5. The steps and methods of conducting a Voting Session of claims 1 to 17 whereby Officials according to claims 1 to 5 perform any number of times, for any number of Potential Voters or Eligible Voters of claim 1, the steps and methods such as, but not limited to: determining, assigning, sorting, organizing, packaging, addressing, delivering or transmitting, receiving or accepting, recording and storing, tallying, publishing or otherwise processing according to (but not limited to) claim 9, any number of Master Ballots, or, any number of Master Voter Registration forms, or any number of Master Voter Language forms, or any number of related documents of information or instruction, any number of self-addressed envelopes, any number of postage pre-paid stamped, self-addressed envelopes, using any combination of, but not limited to: in person, by postal service mail, by third party delivery service, by designated representative (proxy), electronically using any number or combination of computers, computer software programs, telephones, facsimile (fax) machines or software, optical scanners, computer programs, audio recording and playback systems, video recording and playback systems, communication networks, cable television systems, electronic mail, encryption and decryption methods, data compression and decompression methods, data organization and retrieval using computers running software programs and any number of steps and methods of (but not limited to) claim 9 herein.

6. The steps and methods of conducting a Voting Session of claims 1 to 17, whereby any number of Potential or Eligible Voters receives any number of Master Ballots of claim 2, receives any number of Voter Registration forms of claim 2, or receives any number of Voter Language Forms of claim 2; and the further steps and methods whereby any number of recipients then verify any number of Ballots, forms or other documents by referring to the Election Information portion, or the Due Date portion, or the Due Time portion, or any other information provided to enable the voter to determine validation and usefulness for any ballot, form, document or container of this invention whereby the confirmation employs, but is not limited to, any number or combinations of—telephones, computers, computer software programs, communications networks, fax machines or fax emulation software, cable television systems, electronic mail, optical scanners, or digital cameras, to transmit and receive ballot or form information, as well as confirmation, rejection, or error messages according to claims 1 to 17 as to the Ballot, form or document validity, to or from, any number Election Officials or designated representatives, as well as any processing according to (but not limited to) claims 1 to 17; and the further steps whereby any number of Eligible Voters confirm authenticity of any number of Master Ballots by referring to any number of unique BALLOT VOTING RSID (BALLOT VOTING RSID) or any number of Security Elements or any number of published design features common to any number of Master Ballots (and thus Primary and Receipt ballots), any group of Master Ballots or any individual Master Ballot whereby Security Elements (such as but not limited to FIG. 5 item 3A, 3C1,3B1,3B2) are not limited to being comprised of any type of, and, any number of: Random Symbolic Identifiers (RSIDs), BALLOT VOTING RSID's, BALLOT PASSCODE RSID's, Voter PIN's, physical characteristics or devices, Braille code embossing, optical structures or devices, holograms, electronic devices or structures, magnetic fields or devices, organic or inorganic chemicals, biological materials, genetic materials or genetic structures or genetic sequences, special materials, crystal structures, plastics, metals, gas emissions, electromagnetic radiation, radioactive materials, optical emissions, natural fibers, man-made fibers, microfilm dots, microscopic writing, embossing, photosensitive symbols, photosensitive text, or photosensitive images, electronic codes, optical codes, optical or digitized pictures, codes embedded within optical pictures or digitized pictures, watermarks, impressions or seals of authenticity integral, affixed or associated, and any other physical, electronic, electromagnetic, optical, chemical or biological structures, devices or properties associated with any number of (but not limited to): Master, Primary or Receipt—Ballots, Voter Registrations, Voter Language Forms or their delivery Containers; and the further steps and methods of creating any number of, and any type of RSID (such as, but not limited to: Random Symbolic Identifier, Sequential Symbolic Identifier, Group Pattern Random Symbolic Identifier, Group Pattern Sequential Symbolic Identifier, etc.) used in any type of object, such as but not limited to ballots, documents, forms, containers; whereby these steps are taken in a logical order such as (but not limited to): (a) valid RSID's created by the Voting Session Officials be kept absolutely secret from all other Voters before and during the voting session; (b) any public RSID used for test trial voting or information purposes should be disallowed in the actual voting records and tallies; (c) to maintain secrecy, before and during the Voting Session, each RSID is known only to the Officials and whomsoever has a PRIMARY or RECEIPT Ballot; (c) defining the maximum number of Random Symbolic Identifiers needed to ensure that any one RSID is unique and extremely difficult to guess. (e.g. but not limited to: 1,000,000,000); (d) officials calculate the number of binary digits needed describe the maximum number of Random Symbolic Identifiers (such as, but not limited to: 24 binary digits gives over 16,000,000 unique combinations); (e) officials by manual cerebral determination or by computers run software programs employing rigorous mathematical concepts to calculate the number of unique RSID symbols needed to enable generating a sufficient number of unique permutations of symbols to be assigned to each Ballot of the Voting Session (e.g. 2 letters A,B yields 4 unique permutations AA, AB, BA, BB); (f) Officials use existing symbols (such as but not limited to: numbers, characters of an alphabet, etc.) or design new symbols, ensure there is a large set of unique symbolic characters to choose from when randomly selecting and constructing any number of RSIDs and any number of correlated codes; then (g) assign a unique (for example, but not limited to) binary value to each symbol of the set, (h) followed by randomly selecting from the set of unique symbols for the purpose of assembling a unique group of symbols to comprise each RSID, (i) also eliminating symbols that have a similar appearance so as to avoid misinterpretation or confusion by voters, (j) as well as limiting the number of times a single symbol can be repeated in a series of symbols so as to avoid misinterpretation or confusion by voters; (k) Officials organize each type and group of RSID's so as to be rapidly retrievable with a minimum of processing according to (but not limited to) claim 9 for authentication and validation, by methods such as, but not limited to: hybridized implementations of n-dimensional software trees, sparse matrices, hashing, weighted arrays of linked elements.

7. The steps and methods of conducting a Voting Session according to claims 1 to 17, whereby any number of Voters according to claims 1,2,6,8 perform any number of additional steps according to claims 12,15,16 before revealing Ballot Privacy Code RSID, marking or casting their Ballots of claim 2, to determine whether any number of Master Ballots they are evaluating were not previously used to Vote, and if the Ballot is confirmed as not previously having been used to vote, the Voters exchange, any number of times, any number of Master Ballots they possess for other similar Master Ballots possessed by any number of trusted Eligible Voters or any number of Voting Session Officials or their designated agents, whereby this steps and methods are unique among inventions to preserve the anonymity of any Voter, and thus, every Voter, since Voting Session Officials cannot determine which Voters used these steps/methods; In essence, Ballots are like treated like currency, whereby any Eligible Voter can use the Master Ballot, which would be exchanged in kind for an identical Master Ballot in a Voting Region-Zone, as per the Election Rules; Even if a BALLOT PASSCODE were revealed, the voter can determine electronically or in person, whether the Master Ballot has already been used to Vote; using hard to fake Security Elements, traceable BALLOT VOTING RSIDs, and dealing with known to be trustworthy people, assist Voters to ensure they exchange their Master Ballot(s) for valid, authentic Master Ballot(s)); and the further steps and methods of claims 7, 15 whereby the Voter optionally does NOT open the sealed or encrypted Master Ballot Container to verify the validity of the Ballot; and the further steps and methods of claims 4 to 15 whereby the Voter according to claim 15, does use any number of BALLOT PUBLIC VERIFY RSIDs, any number of BALLOT PASSCODEs, as well as any number of other information and security elements displayed to verify Ballot usability and validity, which may be, but is not limited to: display on the exterior of the sealed Master Ballot container, or, printed on a separate wrapping that is visible through a window of the sealed container, or, encoded as a component of any number of digital files, such as, but not limited to: an encrypted email message with an encrypted file attachment; and the further steps and methods whereby each BALLOT VOTING RSID and any number of correlated BALLOT PRIVACY CODES are used to authenticate and verify exactly one Master Ballot Container and any number of MASTER BALLOT PRIVATE VOTING RSIDs within the correlated Master Ballot Container, without revealing any MASTER BALLOT PRIVATE VOTING RSID to anyone handing or exchanging any number of Master Ballot Containers, until such time a Master Ballot Container is opened and any number of MASTER BALLOT PRIVATE VOTING RSID(s) are revealed and further authenticated in correlation with any number of associated BALLOT VOTING RSID(s) and any other information associated with the Master Ballots or Master Ballot Container from which the Master Ballot was extracted.

8. The steps and methods of conducting a Voting Session according to claims 1 to 17 whereby any number of Voters who are deemed Eligible Voters or Proxy Voters according to claims 1 to 5, complete any number of Master Registration Forms of claim 2, then keep any number of Receipt Registration forms, then sends, transmits, or delivers in person or by mail or designated third party, or transmits optically, electronically or otherwise transmits according to (but not limited to) claim 9, or by any other acceptable means conveys, any number of Primary Registration forms, Receipt Registration forms or Master Registration forms to any number of Officials or any number of Officially designated Receivers of Registration forms according to the rules of the current Voting Session; and the further steps and methods according to claims 1 to 5 whereby any number of Voters of claim 1, complete any number of Master Language forms of claim 2, then keep any number of Receipt Registration forms, then send, transmit, or deliver in person or by mail or designated third party, or transmits according to (but not limited to) claim 9, or by any other acceptable means conveys, any number of Language Forms Master, Primary, Receipt) to any number of Officials or Designated Receivers according to the rules of the current Voting Session; and subsequently, the further steps and methods according to this claim and claims 6 and 7 whereby each Eligible, Registered Voter then completes any number of Master Ballots whereby each Voter chooses any number of Candidates and/or any number of Proposals on their PRIMARY ballot, whereby they mark may be a circle, X, filled in circle, or whatever other mark, in whatever form (e.g such as but not limited to: pencil mark, electronic mark) as per Rules of the Voting Session; and the further steps and methods whereby any umber of Voters keep any number of Receipt Ballots that are correlated to their completed PRIMARY Ballot; and the further steps and methods whereby any number of Voters sends, transmits, or delivers, in person or by mail or designated third party, and/or delivers according to (but not limited by) claims 9,14,15 or, by any other acceptable means conveys any number of Primary Ballots, Receipt Ballots or Master Ballots to any number of Officials or Officially designated Receivers of Ballots according to Voting Session rules.

9. The steps and methods of conducting a Voting Session according to claims 1 to 17 whereby Officials processing of Ballots, forms, documents or any other form of information comprises of (but is not limited to) the steps and methods of: researching, identifying, defining, designing, verifying, correlating, authenticating, amending, certifying, preparing, organizing, sorting, assembling, recording, storing, printing, publishing, distributing, receiving, creating, assigning, attaching, linking, embedding, encoding, decoding, encrypting, decrypting, compressing, decompressing, converting, accepting, receiving, recording, electronic scanning, optically scanning, recording, enhancing, storing, creating any number of identical duplicate backup copies, correlating, tallying, counting, calculating, correlating, associating, searching, sorting, organizing, marking, labeling, tagging, identifying, acknowledging, error identification, error recording, error correction, error transmission, error reception, error reporting, authenticating, verifying, validating, certifying, summarizing, reporting, communicating, printing, publishing, transmitting, receiving, compressing, decompressing, encrypting, decrypting, interpreting, converting, locating, detecting, reading, receiving, interpreting, translating, transmitting data to, and receiving data from, any number of—humans, legal entities, computers, electronic, mechanical or optical devices, telephones, communications networks and is to include all steps and methods of translating human and device readable codes to modes, protocols or methods of communication, transmission, reception, decryption, encryption, compression, decompression, as well as, (but not limited to) the steps and methods of locating, receiving, detecting, interpreting, translating, reporting, and transmitting error free data, and the further steps of locating, receiving, detecting, interpreting, translating, reporting transmitting, and correcting compromised data, erroneous data, duplicate data or duplicate transmissions; and the further steps and methods, whereby the aforementioned functions, operations and processing of this claim are performed by (but not limited to) any combination and any number of either singularly or any plurality of—Official persons, designated agents, data acquisition devices, electronic, electromagnetic, optical or biological or other computing or analytical devices, communication networks, any other man-made devices, computers, microprocessors, computer software programs, telephones, facsimile (fax) machines, fax software, optical scanners, audio recording equipment, audio playback systems, video recording equipment, video playback systems, communication networks, cable television systems, electronic mail, data encryption methods, data decryption methods, data conversion methods, data reconstruction methods, data compression methods, data decompression methods, data inventory software, data organization software, data tracking software, data retrieval software, printing software, printers, package labeling software and equipment, package identification software, package tracking software, either separately, or, in combination with of any number of (but not limited to) Security Elements of claim 6; and for any number and type of object of this invention, (such as, but not limited to: Ballots, Registration Forms), the further steps and methods to scan any number of groups of human readable words, numbers and symbols that are correlated to each barcode, then comparing each to the information derived from the scanned barcode for mutual corroboration of accuracy, and the further steps of recording the results of comparison and signaling any number and type of error messages.

10. The steps and methods of conducting a Voting Session according to claims 1 to 17, whereby according to claims 6,7,8,9 Officials do accept, receive, acknowledge, sort, organize, record, store, tally, calculate, summarize, print or publish or otherwise process according to claims 1 to 9, any number of Voter Lists of claim 1, any number of Voter Registrations (Master, Primary, Receipts) of claims 2,7,8 any number of Voter Language Master, Primary, Receipts) of claim 2,7,8 or any number of Ballots (Master, Primary, Receipts) of claims 2,7,8; and the further steps and methods whereby each received Voter Registration form, each Voter Language form, or each Ballot is assigned a new, unique record in a record system which comprises of a new record identifier, date, time, location, and any number of other attributes are updated to describe the receiver and various status conditions for each unique Ballot, Registration or Language form—any number of Ballots, any number of Voter Registrations, any number of Voter Language forms—of which processing for Ballots includes (but is not limited to), each portion containing any number of candidates, proposals or candidates and proposals correlated with any number of barcodes and further correlated with a portion of the area assigned to mark or record each voter selection, voting information including (but not limited to) at least one voting region identifiers (a.k.a. primary voting zones), any number of subsidiary voting region identifiers (a.k.a. secondary voting regions-zones), any number of polling station identifiers, any number of postal code identifiers, any number of zip codes identifiers, any number of geographic location identifiers, any number of election type identifiers, any number of due date identifiers, any number of due time identifiers, any number of expiry date identifiers, any number of expiry time identifiers, any number of election identification identifiers, any number of other codes or other identifiers, any number of any number of Security Elements, at least one BALLOT VOTING RSID or Registration RSID, any number of BALLOT PASSCODE RSIDs, any number of Validation RSIDs, any number of Validation Passcodes, any number of Voter PINs—of which processing for any number of Voter Registrations includes (but is not limited to) processing any number of personal identifiers, any number of printed names, any number of signatures, any number of date information, any number of location information; any other Registration information—of which processing for any number of Voter Language forms includes (but is not limited to) processing any number of personal identifiers, any number of Voter Language Selections information, any number of date information, any number of location information; any other Language information; as well as the steps and methods for each Ballot, Registration or Language form of correlating of each aforementioned identifier or to the respective barcodes or other optical scanning markings or encodings, or electronic processing markings or encodings; and the further steps and methods of creating, assigning, attaching, linking and processing additional encoding for electronic or optical submissions to ensure accurate processing according to claims 8,9; and the further steps and methods of data storage, retrieval and organization of received Ballots, Voter Registrations and Voter Language forms so as to be easier to record, tally, identify, sort, store, locate, retrieve, publish or otherwise process according to claim 9; and the further steps and methods whereby Officials create, distribute and otherwise process (according to claim 9) any number of acknowledgements for each Master Voter Registrations, Primary Voter Registrations, Receipt Voter Registrations, Master Ballots, Primary Ballots, Receipt Ballots, Master Voter Language forms, Primary Voter Language forms, Receipt Voter Language forms, received from any number of Eligible Voters of claim 1, any number of Potential Voters of claim 1, or any number of Ineligible Voters of claim 1, and any number of designated representatives (proxies) or any other approved legal entities of claim 1; and the further steps and methods whereby Officials receiving any number of PRIMARY Ballots, or, any number of RECEIPT Ballots, or, any number of both PRIMARY Ballots and RECEIPT Ballots, and any number of any other type of object, such as, but not limited to: Voter Registration Form of claim 2; and the further steps and methods whereby at least one Official accepts or rejects the validity and authenticity of each ballot, form, document or container; and the further step of at least one Official validating then accepting any number of AUTHENTICATED, VALID ballots for recording and tallying; and the further steps and methods whereby at least one Official determines whether each received ballot (document, form, etc.) were previously processed or recorded in the current Voting Session; and the further steps and methods whereby at least one Official designates any number of verified, authenticated ballots that were submitted only once for the voting session as being CERTIFIED ballots or other objects such as but not limited to: Voter Registrations, etcetera; and the further steps and methods whereby all Officials accept only CERTIFIED ballots (documents, forms, etc.) for recording, tallying, calculating, summarizing publishing and certifying of interim or final voting session results; and the further steps and methods whereby Officials record, tally, summarize, calculate and publish privately and/or publicly any number and any part of any number of documents received by Officials; and the further step of organizing received Ballots so as to be easier to locate and retrieve for verification; and the further step of separating, recording, marking and processing according to claims 1-17 of this invention, so as to distinguish any number of voter registrations, ballots, and other documents that were received in a timely manner from those that were not; and the further steps and methods of generating and recording, from a standardized common reference, the date and time that the voter registration, ballot or documents was created, issued, sent, received or otherwise processed according to claims 1 to 17, including methods such as, but not limited to: event processing Date & Time stamping; and the further steps and methods of correlating each date and time of a processing event to each corresponding document, voter registration and ballot, for any number of documents, voter registrations, ballots, voters, officials; and the further steps and methods voter methods of employing computers running software programs with standard, private algorithms that utilize data (such as, but not limited to: the voting session id, date&time stamp, the correlated unique document identifier—such as, but not limited to document ID, voter registration ID, Voter Privacy RSID)—to generate any number of unique Voter Transaction ID (VTID) any number of which is issued to the Voter to provide a means to publicly validate the Voting action(s), (and any other information deemed reasonable by Officials) without revealing a voters private Voter Registration ID or Ballot Voter Privacy RSID or Voter PIN; and the further steps and methods of correlating, recording, storing, publishing and otherwise processing according to claims 1 to 17, all Voter Transaction ID's associated with the Voting Session; and the further steps and methods whereby any number of unique Officials Transaction ID (OTID) is also generated and correlated to the Voter Transaction ID (VTID which identifies the human, computer, and any other noteworthy devices, their location(s), communications data and any other information such as, but not limited to: systems status, diagnostics data, success messages, error reporting.

11. The steps and methods, according to claims 9 and 10, whereby any number of times, for each Ballot or each Voter Registration or each Voter Language form or any other document or Container (Ballot, Registration) that is created, printed, sent or received and found to contain an RSID or any other ID that is determined to have been previously submitted, the Ballot or form is identified, uniquely marked, recorded, tallied, removed and stored separate from all tallies of valid, authenticated, certified ballots, for further investigation along with all other Ballots sharing the same unique RSID or Voter Registration ID or Voter Language ID, as well as the further steps and methods of determining, any number of times, the truly authentic, valid, certifiable Ballot or Voter Registration, from a group of duplicate submissions, and the further step of restoring each authentic, valid, certifiable Ballot or Voter Registration or Voter Language form to normal processing steps associated with all valid, authentic, certified Ballots, Voter Registrations or Language forms or any other type of Container (such as but not limited to Ballot Container, Registration Container) in any form (such as, but not limited to: paper, electronic file).

12. The steps and methods according to claims 1 to 17 whereby any number of Voters request any number of replacements of any number of Voting Session Items such as, but not limited to: Ballots of claim 3, Registration Forms of claim 2; and the further steps whereby any number of Officials determine, for each Voter, the appropriateness to provide any number of replacement objects for any number of Voters requesting replacements; and the further steps and methods whereby any number of Officials provide any number of replacement items to any number of Voters; and the further steps and methods whereby at least one Official records ALL relevant data regarding the replacement items provided and the recipient voter the item was provided to, so as to accurately amend the Official records.

13. The steps and methods of conducting a Voting Session according to claims 1 to 17, whereby according to claim 12, election officials provide unalterable, immutable form (such as a securely stored CDROM Master List) of Crucial Integrity Data Items, such as, but not limited to: the main identification RSIDs for any number of—Ballot(s), Container(s), Voter Registration Form(s), Voter Language Form(s), Voter Information Document(s), or any other Document(s), Form(s), Container(s) or data record(s) of this invention that was used in the Voting Session.

14. The further steps and methods of claims 4 to 17 whereby the MASTER BALLOT comprises of a PRIMARY BALLOT, and at least one RECEIPT BALLOT, and at least one unique BALLOT VOTING RSID that is used when voting and is extremely difficult to guess; and the further step of correlating one private, hard to guess, BALLOT PASSCODE to each BALLOT VOTING RSID and each constituent part of a MASTER BALLOT; and the further steps of correlating to each BALLOT VOTING RSID, any number of unique, public MASTER BALLOT CONTAINER VALIDATION RSID(s) that are extremely difficult to guess; and the further steps and methods whereby for each voting session, every BALLOT VOTING RSID and every MASTER BALLOT CONTAINER VALIDATION RSID are constructed to be unique among all RSIDs of this invention, as well as being unique among all “SIGNATURE IDs” of this invention; and the further steps whereby each MASTER BALLOT CONTAINER VALIDATION RSID is correlated to one MASTER BALLOT CONTAINER (such as, but not limited to—a paper envelope, an electronic encrypted container (such as, but not limited to: an encrypted file, a secure webpage, a secure email postbox)) and any number of constituent parts associated with the MASTER BALLOT CONTAINER; and the further steps whereby each MASTER BALLOT CONTAINER VALIDATION RSID may be optionally correlated to each BALLOT VOTING RSIDs within the correlated MASTER BALLOT CONTAINER; and the further steps and methods whereby each MASTER BALLOT VALIDATION RSID is further correlated to any number of MASTER BALLOT CONTAINER SIGNATURE IDs, where a MASTER BALLOT SIGNATURE ID is constructed by computers using software algorithms to generate any number of symbolic or binary codes to enable security and integrity measures for a MASTER BALLOT CONTAINER; and the further steps whereby, in general, any number of MASTER BALLOT CONTAINER VALIDATION RSIDs and any number of MASTER BALLOT CONTAINER SIGNATURE RSIDs are generated, printed, embedded, attached or associated with any number of MASTER BALLOT CONTAINER(s) whereby each MASTER BALLOT CONTAINER SIGNATURE ID is correlated to one MASTER BALLOT CONTAINER; and the further steps and methods whereby any number of details of the voting session (such as, but not limited to—election description, ballot voting political region, poll station ID, candidates, ballot due date and due time, ballot expiry date, etcetera) and any number of Security Elements of claims 2,6,15 (such as, but not limited to hologram, embossed letters, official document seal, BALLOT VALIDATION RSID) are printed, embedded or otherwise associated and displayed clearly and prominently on the MASTER BALLOT CONTAINER, so as facilitate easy ballot validation, integrity and security checks for ballot exchanges, by clarifying exactly which elections and voting region the MASTER BALLOT CONTAINER internal VOTING BALLOT(s) and BALLOT PASSCODE(s) correspond to, as well as what time frame these items are useful for; and the further steps and methods whereby if a MASTER BALLOT CONTAINER is physical (such as, but not limited to: paper envelope, plastic card with embedded electronic circuits), each MASTER BALLOT CONTAINER may be sealed and secured by using security measures of Steps 2,6,15 whereby MASTER BALLOT CONTAINER VALIDATION RSIDs are publicly viewable outside for easy validation, and MASTER BALLOT SIGNATURE IDs manifested inside of security devices of Steps 2,6,9,15 such as, but not limited to: hologram label-seals, electronic circuits, etc.; and the further steps whereby a physical MASTER BALLOT CONTAINER in the paper form may perforated along any number of edges or otherwise may be constructed to securely protect and show any signs of tampering, yet allow easy access to the internal Ballots without damaging either the PRIMARY BALLOT(s) or RECEIPT BALLOT(s) within; and the further steps and methods whereby if the MASTER BALLOT CONTAINER is electronic, the integrity and security of the container and its contents can be verified by using Officials computers running standard, private software algorithms that decode and compare the MASTER BALLOT CONTAINER SIGNATURE IDs with the MASTER BALLOT CONTAINER VALIDATION RSID and then communicate the resultant determination whether the BALLOT CONTAINER is valid, and furthermore whether MASTER BALLOT CONTAINER contents are secure and untampered; and the further steps and methods for each successful Ballot Validation, a sequential BALLOT CONTAINER VERIFIED ID is generated, recorded and stored by Officials; and the further steps whereby each BALLOT CONTAINER VERIFIED ID is correlated to each BALLOT VALIDATION ID it was generated by; and the further steps whereby for any number of BALLOT DELIVERY CONFIRMATION forms (FIG. 24) that are delivered by Voters to Officials, at least one sequential BALLOT DELIVERY CONFIRMATION ID is generated, recorded and stored by Officials, and the further step whereby each BALLOT DELIVERY CONFIRMATION ID is correlated to each BALLOT VOTING RSID of the BALLOT DELIVERY CONFIRMATION form (FIG. 24); and the further step whereby in general, any number of BALLOT DELIVERY CONFIRMATION IDs are generated and correlated to any number of BALLOT VOTING RSIDs for any number of BALLOT DELIVERY CONFIRMATION forms (FIG. 24); and the further steps and methods that any number of Security Elements of claims 2,6,15 as well as any number of steps and methods of claim 9, and any other claims of this invention may also be implemented consistently and effectively to ensure the protection of sensitive data (not limited to: information masking, encryption/decryption and ensuring other criteria such as, but not limited to: data integrity, accuracy, longevity; and the further steps and methods of applying any number of applicable steps and methods of this claim to any part, or, all steps of Voter Registrations of claims 1,2,3 of this invention.

15. The steps and methods of electronic voting (e-Voting) according to claims 1 to 17 of this invention whereby any number of voters can use any number of electronic devices (such as, but not limited to: computers, cell phones, PDA's, fax machines) to connect to any number of communications methods (such as, but not limited to: telephone system, Internet) to securely access and securely submit information to complete any number of documents (such as, but not limited to: voter registrations, voter language preferences, ballot confirmation, primary ballot, receipt ballot) that are then submitted privately and securely to Officials for evaluation, recording, tallying and any further processing according to any number of other claims of this invention; and the further steps whereby any number of Officials generate any number of internet webpages to perform online processing using computers running software programs (such as, but not limited to: securely facilitate Voter login authentication, Voter data input, validate Voter input, present input error messages, communicate Voter selections to the Voter and Officials); and the further steps and methods whereby any number of Officials using computers running software programs to generate any number of internet webpages correlated to each Voter document (such as but not limited to: Voter Registration, Voter Language Preference, Primary Ballot) before and after use by any number of voters; and the further steps and methods whereby each Voter authenticates their access rights and document data processing rights via number of official election computers providing any number of secure communication connections such as, but not limited to: internet-HTTPS, SSL, telephone-encrypted connection, email-encrypted & digitally signed; and the further step whereby any number of Voter electronic authentication may be in any number of forms, such as, but not limited to: data issued by a third party certificate authority to a specific Voter and furthermore to any number of voters using computers, PDA's, telephones, fax machines or any other device; and the further steps and methods of identity masking whereby any number of “electronic voters” who are eligible voters using computers, telephones, fax machines or any number of other devices to connect to Officials computers and related communication systems for electronic voting are enabled by Officials to employ privacy methods such as, but not limited to: IP (internet provider) masking or computer Machine ID masking, or telephone number masking, to hide their unique electronic identity by enabling each electronic voter to appear as another unrelated IP address or telephone number to any number of election computers; and the further steps and methods whereby identity masking employs (but is not limited to) software and/or hardware from third parties that connect to commercial or privately owned computer, routers, telephones or any other device(s) so as to hide, mask, transform or use a third party alias identifier for the voter computer, PDA, telephone, fax machine or any other related devices, whereby any number of electronic voters optionally connect to any number of public or private masking network systems (such as but not limited to: JAP, TOR, VOIP) whereby originating voters personal and electronic device identity may be optionally hidden or transformed so as to be untraceable to a specific voter identity; and the further steps and methods whereby Officials are enabled to monitor all electronic contacts and exclude mischief or malicious electronic voter contacts employing communications devices, human judgement and computers running analytical software; and the further steps and methods whereby a voter may apply the same or similar electronic devices and communications systems of claims 1 to 17 of this invention so as to securely access, verify, validate, input, amend, review, print or save copies of, and/or securely submit any number of Primary Ballots to Officials by providing all necessary data (such as, but not limited to: BALLOT VOTING RSID, Ballot Passcode) relevant to Ballot status (such as, but not limited to: ready2vote, votedOK, Cancelled) so as to enable reviewing or casting of any number of ballots for each registered voter, proxy or appointee; and the further steps and methods of claims 9 and 10 of this invention of separately processing timely and untimely received items such as, but not limited to: registrations, ballots and other documents, data transmissions, mail-in documents, etcetera, in accordance with the Voting Session rules;
and the further steps and methods according to claims 4 to 15 whereby to cast a Ballot or Registration, any number of Voters opens any number of Master Ballot Containers of claims 14 which they possess, and the further steps and methods whereby the Voter is enabled to vote using such methods, but not limited to: voting (or registering) in person, voting (or registering) by postal mail, voting (or registering) Electronically (eVote, eRegister) after revealing, viewing and utilizing any number of BALLOT PASSCODE found in places such as, but not limited to: within the Master Ballot Container, printed on the Primary Ballot, printed on the Receipt Ballot, in conjunction with the BALLOT VALIDATION RSID for that same Master Ballot, Primary Ballot or Receipt Ballot; and the further steps according to claims 4-15 whereby any number of Voters complete any number of Primary Ballots and retain any number of correlated Receipt Ballots for each Primary Ballot they completed or possess; and the further steps whereby any number of Voters deliver any number of Primary Ballots to Election Officials or Officially Designated Recipients for tallying, as well as any number of identical anonymous copies, (for example, but not limited to: using completed Receipt Ballots using methods such as, but not limited to: postal mail, electronic mail, telephone, fax machine, or internet website page(s)), to any number of third party individuals, groups, organizations, committees, news media entities, computers and/or any other devices to verify the integrity and accuracy of the Official count of claims 1 to 17; and the further steps and methods, whereby the steps and methods of electronic voting are performed by any number of Voters employing steps and methods such as, but not limited to: (a) using computers running software and communications systems to connect to the public Internet system, and after any number of intermediate steps to effect measures such as, but not limited to: protect the voter identity, security of data exchanges, thereafter connects the voters computer to at least one Official Internet Voting Website that is secured from tampering; whereupon the Voter uses the computers, internet and software to navigate any number of Official webpage menus to a secure webpage used for verification; where upon accessing this secure webpage, at least one Internet Validation Session ID IVALSID) is created by the Official Computers (running software programs) and then correlated to each connected Voter Internet Session; and the further steps whereby each Voter electronically obtains and utilizes any number of electronic authentication certificates from any number of approved certificate authorities which are then correlated to the respective IVALSID or IVOTSID; and the further steps and methods whereby any number of connected Voters each enter their respective MASTER BALLOT CONTAINER VALIDATION ID or BALLOT VOTING RSID on their local computer using such methods as, but not limited to Internet Browser webpage form and submit that form to the Internet Validation System (IVALS) for processing according to (but not limited to) claim 4,5,6,7,8,9,14 and other methods of this claim; whereafter the IVALS correlates the IVALSID to the RSID submitted, records this information along with, but not limited to: the Voter computer IP address (FIG. 23—item E2), date and time (FIG. 23—item E5a,b), then determines whether there have been statistically numerous RSID submissions from the Voter computer IP address for a given time period, and if so, communicates denial of service to the Voter and stops further processing of the RSID on behalf of that Voter, otherwise whereby IVALS generates a unique Session ID (FIG. 23—item E2), then continues to determine whether the submitted VALIDATION RSID or BALLOT VOTING RSID are valid and any number of other information items; whereby if the Voter enters an RSID that is determined to be valid, the voter is shown STATUS information of the Ballot (such as but not limited to: VOTED-OK, READY2VOTE, DISABLED), but is NOT shown the any BALLOT SELECTIONS made by the Voter; whereby if the Voter enters a BALLOT VOTING RSID and BALLOT PASSCODE or VOTER PIN that is determined to be valid for the BALLOT VOTING RSID, then the voter is shown any number of ballot data elements such as, but not limited to: BALLOT STATUS information, BALLOT PUBLIC VALIDATION RSID, any VALIDATION SIGNATURE IDs, BALLOT CAST CHECKSUM, BALLOT SELECTIONS made by the Voter (FIG. 23 all items), BALLOT SELECTION SIGNATURE IDs (FIG. 23—item G1, with its value correlated to barcode G2) which are described as any number of unique groups of numbers and symbols that uniquely describe a CAST Ballot Voter Selections which are correlated directly to one “parent” MASTER BALLOT VOTING RSID (FIG. 23—item B1); and further steps and methods whereby for each CAST BALLOT, each BALLOT SELECTION SIGNATURE ID and any number of other ballot component values (such as, but not limited to: BALLOT VOTING RSID, date, time, voting method, Validation ID) are further encrypted or encoded using any number of computers using a standardized encryption/encoding algorithm so as to provide a BALLOT CAST SIGNATURE ID (FIG. 23—item F1, with its value correlated to barcode F2) which encapsulates all the ballots vital information (such as, but not limited to: transaction ID, date cast, time cast, Ballot Voting RSID, Ballot Validation ID, Voter Selection Signature ID) in a form such that all this information is compressed and encoded by Official computers running standard, private software algorithms and the steps and methods of claim 9; and the further steps and methods of creating a BALLOT CAST CHECKSUM that is correlated to the BALLOT CAST SIGNATURE ID, so that when the BALLOT CAST SIGNATURE ID is decrypted and compared to the BALLOT CAST CHECKSUM (using at least one computer employing software of a complementary decryption algorithm) and the values are equal this signifies the BALLOT CAST SIGNATURE ID is uncorrupted (otherwise corrupted); and the further steps and methods of this claim and claim 9 whereby when any BALLOT CAST SIGNATURE ID is successfully decrypted using at least one computer employing software of a complementary decryption algorithm then all of the ballots vital information is decompressed, decoded and revealed, including an internally stored BALLOT CAST CHECKSUM to confirm the data was unaltered and that the decryption process was accurate; and the further steps whereby the IVALS prompts the Voter, a limited number of times for each VALID BALLOT VOTING RSID, to provide the BALLOT PASSCODE on a secure form, and the further steps and methods to determine whether the number of attempts to provide either a VALID BALLOT VOTING RSID or VALID BALLOT PASSCODE has exceeded limitations, and the further steps and methods of temporarily disabling the BALLOT VOTING RSID if the number of attempts to provide a VALID BALLOT PASSCODE has exceeded limitations; and the further steps and methods of detecting and blocking too many attempts from a person or computer to guess a VALID BALLOT VOTING RSID; whereafter any number of Official people and/or computers running software programs, determine whether the BALLOT PASSCODE provided is correlated to the BALLOT VOTING RSID; and the further steps and methods whereby if the Voter enters a BALLOT PASSCODE that is determined according to step to be valid for the BALLOT VOTING RSID, and the BALLOT VOTING RSID has an has not been disabled, then the voter receives the VALIDATION RSID, VOTER SELECTIONS and any number of other information items associated with of the BALLOT VOTING RSID; and the further steps and methods according to this claims whereby if the ballot has not been cast, the voter is provided (but not limited to) the options to vote or not vote, and the further steps and methods of the choice of NOT VOTE, the Voter exits Internet Validation System (INETVALS); and the further steps and methods upon the Voter choice to VOTE: the Voter is connected by Official Voting Computer to the Internet Voting System (INETVOTS) webpage, whereby a unique Internet Voting Session ID is generated, stored and associated with the correlated BALLOT VOTING RSID; and the further steps whereby the INETVOTS provides the Voter with any number of choices such as, but not limited to, any number of: Candidates, Proposals, related information items (such as but not limited to: web page hyper-links to Candidate biographies, hyper-links to Candidate political party affiliations and policies, hyper-links to Proposal descriptions), and options to process the Voting form (such as, but not limited to: SUBMIT, CANCEL, RESET, PAUSE, SAVE, EXIT), as well as the options to locally store (SAVE2PC, PRINT) and communicate (EMAIL, PUBLICVIEW) selections made; and the further steps and methods whereby the Voter completes and submits their Ballot selections and any number of errors are detected and identified to the Voter by software program code and scripts embedded in the Official webpage and/or by IVOTS computers running software programs; and the further steps whereby any number of corrections are made, any number of times by the Voter until all the Ballot selections are error free; and the further steps whereby the Voter submits their error-free Ballot and Selections for final processing to the IVOTS; and the further steps and methods whereby for each BALLOT VOTING RSID, BALLOT PASSCODE and Voter Selections that are successfully submitted (cast) by Voters and successfully processed by Officials, that at least one BALLOT CAST TRANSACTION ID (FIG. 23, item E4) is generated and then correlated to the BALLOT VOTING RSID (FIG. 23—item B1) and further correlated to the originating IVOTS Session ID; and the further steps whereby for each CAST BALLOT that is processed successfully, the Voter is given the option to enter a private VOTER PRIVACY CODE of their own construction, which is correlated to the BALLOT VOTING RSID; and the further steps whereby for each successfully CAST BALLOT, the respective BALLOT VOTING RSID (FIG. 23—item B1) and correlated BALLOT VALIDATION ID (FIG. 23—item C1, which has a value that is correlated to barcode C2) are further correlated to at least one sequential BALLOT CAST TRANSACTION ID (FIG. 23—item E6a, which has a value that is correlated to barcode E6b); and the further steps whereby the IVOTS RECEIPT ID, Session ID, BALLOT VOTING RSID, BALLOT PASSCODE, BALLOT VALIDATION ID, Ballot Selections, VOTER PRIVACY CODE, VOTER SELECTION SIGNATURE, BALLOT VOTECAST SIGNATURE, and any number of other related information items are permanently, redundantly stored, as well as transmitted securely to, and received by, but not limited to: any number of Election Officials, Political Parties, Candidates, and any number of other approved third parties (such as, but not limited to, independent, non-partisan vote auditors, the news media), for actions such as, but not limited to: verification and accounting in any number of formats (such as, but not limited to: printed, Television Broadcast, electronic file (such as but not limited to: webpage, email, pdf, jpeg) for example, such as but not limited to: using the unique, private BALLOT VOTING RSID as part of an Internet address to organize and privately store each voter webpage, as well as tallies and summaries of voter selections) employing any number of methods of processing according to (but not limited to) claim 9; and the further, optional, steps and methods for each INTERNET Ballot, of detecting, reporting, and stopping processing of appropriate Ballot cast via IVOTS upon detecting NOT timely receiving the BALLOT DELIVERY CONFIRMATION (FIG. 24), or, disregarding any number of failures of delivery of any number of BALLOT DELIVERY CONFIRMATION that are correlated to an INTERNET Ballot cast via the Internet Voting System (INETVOTS); and the further steps and methods of any number of Officials generating and making securely available, at least one webpage describing details of the voting session and also providing access to the official eVoting Receipt (FIG. 23) for each successful INETVOTS Voter and any number of Officials; and the further steps and methods of encrypting and decrypting any number of Internet Communications Sessions using the methods of, but not limited to: claims 4,5,6,7,8,9,14,15 and any further methods of this claim;
(b) and the further, similar steps and methods of Electronic Voting such as, but not limited to: Telephone Validation and Telephone Voting whereby any number of Voters employ any number of Telephony communications devices such as, but not limited to: Telephone, Cell Phone, PDA device or any other personal telecommunications device, to validate and cast any number of documents (such as, but not limited to: Voter Registration, Voter Language Preference, Voter Primary Ballot); and the further steps whereby any number of Voters use any combination of signaling methods (such as, but not limited to: telephone keypad signals, spoken words, display menu choices, display cursor movement) to navigate through any number of menus and any number of menu options to interact with the Telephone Validation System (TELVALS) and Telephone Voting System (TELVOTS); and the further steps and methods whereby each Voter connected to the uses a telephone, cell phone or PDA or any other personal telecommunications device to enter required data (such as, but not limited to BALLOT VOTING RSID, BALLOT PASSCODE, Voter Selections), as well as and number of repetitions of steps such as, but not limited to: validate, review, confirm, amend, and submit their document for processing; and the further steps whereby any number of signal recording devices (such as audio, data, voltage) are automatically connected and record the Telephony Communication Session (TCS) and the further steps whereby for each Telephony Communications Session, a unique Telephone Validation Session ID is created and correlated to the audio recording; and the further optional step whereby the Voter Telephone Number (to detect issues such as, but not limited to: excessive RSID guessing); and the further similar steps and methods of the previously mentioned Internet Validation and Internet Voting procedures, as modified to be applied to Telephone Validation and Telephone Voting; and the further optional steps and methods for each Telephone Ballot of detecting, reporting and stopping processing of the appropriate Telephone Ballot from being cast upon detecting failure of timely receipt of any number of correlated Voter's MASTER BALLOT DELIVERY CONFIRMATION (FIG. 24), or alternatively, disregarding any number of failures of delivery of any number of Voters MASTER BALLOT DELIVERY CONFIRMATION documents; and the further steps and methods of encrypting and decrypting any number of Telephony Communications Sessions using the methods of, but not limited to: claims 4,5,6,7,8,9,14,15 and any further methods of this claim; and the further steps and methods of any number of Officials generating and making securely available, at least one webpage describing details of the voting session and also providing access to the official eVoting Receipt (FIG. 23) for each successful TELVOTS Voter, and any number of Officials; and the further steps and methods of encrypting and decrypting any number of Telephony Communications Sessions using the methods of, but not limited to: claims 4,5,6,7,8,9,14,15 and any further methods of this claim;
(c) and the further steps and methods of Electronic Voting such as but not limited to Facsimile Validation and Facsimile Voting; whereby any number of Voters employ an electronic facsimile device or computer running facsimile processing software along with any combination of devices and/or software such as, but not limited to optical scanning, image processing and text recognition software, in conjunction with any number of and types of communications system(s) and methods according claim 9 and any other claims of this invention, so as to connect to the FAX Validation System (FAXVALS) and thereafter the FAX Voting System (FAXVOTS) similar to the steps and methods of Internet Voting; and the further steps and methods whereby any number of Voters use at least one device (such as a facsimile machine or a computer connected to an optical scanner) and any number of software programs of the device to convert their document (in physical or electronic form into a facsimile of the original document and then uses the device to submit any number of documents (such as, but not limited to Voter Registration, Voter Ballot) to any number of election officials via at least one communication system (such as, but not limited to: telephony, internet); and the further steps whereby any number of Officials and Officals devices receives any number of Voter Facsimile Documents; and the further steps whereby each facsimile received is recorded and stored along with relevant information (such as, but not limited to: date & time of receipt, transmission source) along with a Voting Session unique FAX-ID that is generated manually or by any number of Officials computers running software programs; and the further similar steps and methods of the previously mentioned Internet Validation and Internet Voting procedures, as modified to be applied to Facsimile Validation & Facsimile Voting; and the further steps and methods of scanning each fax manually by humans or using any number of optical scanners, and/or any number of computers running at least one optical character recognition software program, and/or image processing software using any other steps of claim 9 to extract, store, mark correlate and otherwise process the data on the facsimile in accordance with the procedures for the type of document received and claims 1-17 of this invention; and the further optional steps and methods for each FAX Ballot, of detecting, reporting and stopping processing of the appropriate FAX BALLOT from being cast via FAXVOTS upon detecting failure of timely receipt of any number of Voters correlated MASTER BALLOT DELIVERY CONFIRMATION, or, disregarding any number of failures of delivery of any number of Voters MASTER BALLOT DELIVERY CONFIRMATION documents that are correlated to a FAX Ballot cast via the FAXVOTS; and the further steps and methods whereby any type of Electronic Validation and Electronic Vote (such as, but not limited to: Internet, Telephone, Fax, E-mail) can optionally be rejected for failing to provide, in a timely manner, an original PRIMARY BALLOT or RECEIPT BALLOT; and the further steps and methods of any number of Officials generating and making securely available, at least one webpage describing details of the voting session and also providing access to the official eVoting Receipt (FIG. 23) for each successful FAXVOTS Voter, and any number of Officials; and the further steps and methods of encrypting and decrypting any number of Facsimle Communications Sessions using the methods of, but not limited to: claims 4,5,6,7,8,9,14,15 and any methods of this claim;
(d) and the further steps and methods of Electronic Voting such as, but not limited to eMail Validation and eMail Voting, whereby any number of Voters employ any number of electronic devices (such as, but not limited to: a computer, telephone or PDA) running email transmission and reception software along with any combination of devices and/or software (such as, but not limited to: optical scanning, image processing and text recognition software), in conjunction with any number of and types of communications system(s) and methods according claims 9 and any other claims of this invention, so as to connect to the FAX Validation System (FAXVALS) and thereafter the FAX Voting System (FAXVOTS) employ steps and methods similar to Internet & Facsimile Validation, Internet & Facsimile Voting; and the further steps and methods whereby any number of Voters use at least one device (such as a facsimile machine or a computer connected to an optical scanner) and any number of software programs of the device to convert their document (in physical or electronic form) into a facsimile of the original document and then uses the device to submit any number of documents (such as, but not limited to Voter Registration, Voter Ballot) to any number of election officials via at least one communication system (such as, but not limited to: telephony, internet); and the further steps whereby any number of Officials and Officals devices receives any number of Voter Facsimile Documents; and the further steps whereby each facsimile received is recorded and stored along with relevant information (such as, but not limited to: date & time of receipt, transmission source) along with a Voting Session unique FAX-ID that is generated manually or by any number of Officials computers running software programs; and the further steps and methods of scanning each fax manually by humans or using any number of optical scanners, and/or any number of computers running at least one optical character recognition software program, and/or image processing software using any other steps of claim 9 to extract, store, mark correlate and otherwise process the data on the facsimile in accordance with the procedures for the type of document received and claims 1-17 of this invention; and the further optional steps and methods for each FAX Ballot, of detecting, reporting and stopping processing of the appropriate FAX BALLOT from being cast via FAXVOTSYS upon detecting failure of timely receipt of any number of Voters correlated MASTER BALLOT DELIVERY CONFIRMATION, or, disregarding any number of failures of delivery of any number of Voters MASTER BALLOT DELIVERY CONFIRMATION documents that are correlated to a FAX Ballot cast via the FAXVOTSYS; and the further steps and methods whereby any type of Electronic Validation and Electronic Vote (such as, but not limited to: Internet, Telephone, Fax, E-mail ) can optionally be rejected for failing to provide, in a timely manner, an original PRIMARY BALLOT or RECEIPT BALLOT; and the further steps and methods of any number of Officials generating and making securely available, at least one webpage describing details of the voting session and also providing access to the official eVoting Receipt (FIG. 23) for each successful FAXVOTSYS Voter, and any number of Officials; and the further steps and methods of encrypting and decrypting any number of Facsimile Communications Sessions using the methods of, but not limited to: claims 4,5,6,7,8,9,14,15 and any further methods of this claim;
and the further steps and methods whereby for each electronically submitted and successfully processed Primary Ballot at least one eVoting Receipt (FIG. 23) is generated and delivered to the Voter who submitted the Primary Ballot; and the further step whereby at least one eVoting Receipt (FIG. 25) is generated and stored by Officials, and the further step whereby any number of eVoting Receipts are delivered to any number of third parties such as, but not limited to: the media, the candidates; and the further steps of applying any number of the aforementioned steps and methods, actions, data or results any number of times, to any number of Ballots, Voters, Officials, or other legally recognized entities, by any number of Voters, Officials or other legal entities; and the further steps and methods of Voting Receipt Encryption to ensure data integrity of receipt ballots by reducing the possibility of falsification and ballot tampering—the steps and methods whereby any number of election computers encrypt any number of ballot receipt information (such as, but not limited to: BALLOT VOTING RSID, voter selection validation codes, receipt sequence ID, receipt validation code, date and time stamp) so that any number of public encrypted ballot receipt codes (PUB-EBRC) are created to obscure the original ballot receipt voting information by using at least one private encryption digital number (a private encryption key: PRI-KEY) and a private encryption algorithm (PRI-ENALG), and the further steps and methods whereby each original ballot receipt information is recoverable from the correlated public encrypted ballot receipt code (PUB-EBRC) by applying manually or by computer, the correlated private receipt encryption key (PRI-KEY) and the correlated private receipt encryption algorithm (PRI-ENALG) to the correlated public encrypted ballot receipt code (PUB-EBRC); and the further steps and methods, such as but not limited to:
i) any number of public encrypted or non-encrypted ballot receipt codes (PUB-EBRC) (FIG. 25—item F1,G1 are encrypted, items C1, E4 are not encrypted) are each correlated to their “parent” BALLOT VOTING RSID (FIG. 23—item B1) and Validation ID (FIG. 25—item C1), then correlated to the other Ballot Voting Receipt Elements prior to data storage on Official computer devices, followed by printing to Ballot Voting Receipt (e.g. FIG. 23) which can be in any format such as, but not limited to: a paper document, electronic file, etcetera, and may optionally include any number of correlated barcodes for any value of a data element being printed on/to the receipt (E4::E5, F1::F2, G1::G2, etc.);
ii) any number of PRIVATE encryption algorithms (PRI-ENALG) of this step are unique overall this invention and at least at least one PRIVATE encryption key (PRI-KEY) is unique for each PRI-ENALG of this invention;
iii) whereby any number of PUBLIC encryption algorithms (PUB-ENALG) and PUBLIC encryption keys (PUB-KEY) are provided and employed to enable general public validation of ballot receipts data and ballot receipt codes without revealing the private encryption algorithms (PRI-ENALG) or private encryption keys (PRI-KEY).
iv) whereby to facilitate machine scanning, any number of barcodes and/or other symbolic marking codes are generated and correlated to any number of ballot information data elements and any number of public encrypted ballot receipt codes, then printed on or otherwise incorporated into the ballot receipt;
v) whereby to facilitate machine scanning, any number of geometric shapes, lines and/or other symbolic marking codes to be used for orientation or alignment are generated then printed on, or otherwise incorporated into the ballot receipt;
and the further steps and methods of applying any number of any of the aforementioned steps and methods, actions, data processing or results any number of times, to any number of documents, such as but not limited to: Voter Registrations, Voter Language Preferences; and the further steps whereby at least one Official generates at least one eRegistration Receipt (FIG. 22) for each Voter Registration (FIG. 1,2,3,4,16); and the further steps of any number of Officials generating any number of eRegistration Receipts (FIG. 22) for any number of Voters, Potential Voters, and Officials; and the further steps and methods of any number of Officials generating and making securely available, at least one webpage describing details of the eRegistration Session and also providing access to the official eRegistration Receipt (FIG. 22) for each successful eRegistration, and any number of Officials; and the further steps and methods of encrypting and decrypting any number of eRegistration Communications Sessions using the methods of, but not limited to: claims 4,5,6,7,8,9,14,15 and any further methods of this claim;
and the further steps and methods according to claim 10 of this invention in creating and assigning any number of Voter Transaction IDs (VTID) and any number of Official Transaction ID's (OTID's) to any number of ballots, documents, registrations, events or steps and methods of this claim and claims 1 to 17.

16. The steps and methods according to claims 1 to 15 whereby Officials provide steps and methods for each Ballot, Voter Registration, Voter Language Form, or any other items related to the Voting Session that is received, such that a certified copy is made available to at least one Eligible Voter for verification and error detection, and that at least one means, method and opportunity of reporting errors is provided, and the further steps and methods whereby any number of Officials, or any number of Eligible Voters, or at least one designated representative (proxy) that possess the unique combination of the BALLOT VOTING RSID and BALLOT PASSCODE for each disputed Voter Registration or Ballot submits the Voter Registration or Ballot electronically to Officials using, but not limited to: any number or combinations of: telephones, computers, computer software programs, communications networks, fax machines or fax emulation software, cable television systems, electronic mail, optical scanners, digital cameras, as well as software and devices for detecting, correcting and recording any errors of content or transmission, or, any number of errors are reported by presentation of any number of sufficiently intact physical Ballot (Master, Primary or Receipt) of claim 2 or any number of Voter Registrations (Master, Primary, or Receipt) of claim 2, or Voter Language forms (Master, Primary, Receipt of claim 2, or any number of Master Ballot Containers of claim 1-15, by any number of Potential Voters, Eligible Voters or designated representative (proxy) Voters of claim 1, for each disputed: Voter Registration, Voter Language Form, Ballot (Master, Primary, Receipt), or Container (such as, but not limited to: Voter Registration Container or Master Ballot Container); and the further steps and methods whereby for any number of special persons or other special legal entities (such as but not limited to news media, political candidates) that are authorized by a Voter owning an appropriate, bona fide Receipt, to be given access to any electronic, digital, or any other transformed version of any printable Ballot, Form, Document or Container of this invention, the Officials will provide a certified copy or representation of any number of items identified as Crucial Integrity Data Items of claim 13; and the further steps and methods, according to claims 1 to 17, of conducting a Voting Session whereby at least one Official provides each Voter with at least one method, and at least one opportunity, to verify or correct the accuracy of the Official Record of any record, tally, calculation, summary, or publication pertaining to any certified ballots or certified ballot vote selections; and the further steps and methods whereby any number of Voters, or authorized legal entities, use their RECEIPT Ballot and any number of methods to verify the accuracy of ballot processing (or any other document/record processing), such as, but not limited to: using a telephone, or, a computer connected to the Internet, any number of Voters verify or reject any Official record, tally, calculation, summary, or publication of their PRIMARY Ballot or voting selections made on their PRIMARY Ballot; and the further steps and methods whereby any number of Voters notify Officials to investigate and correct any number of errors discovered; and the further steps and methods whereby at least one Official records each Voter request to investigate, with all relevant details; and the further steps and methods whereby any number of Officials proceed to investigate whether to accept or reject each Voter request to amend any number of errors, then report to any number Voters and/or authorized legal entities, as to whether an amendment is required as requested, along with each Official findings of the investigation which is all duly recorded in the official records; and the further steps and methods if required, whereby at least one Official then amends the records, tallies, summaries, calculations, and publications to correct the records and tallies of any number of PRIMARY Ballots, or voter selections made on the PRIMARY Ballots, in accordance with the findings and the Rules of the Voting Session; and the further steps and methods whereby at least one Official verifies any amendments were completed accurately; and the further steps and methods whereby at least one Officials records in the Official records, and reports to any number of Voters or other interested legal entities as to when the amendments are completed, along with the results of the Official verification of the amendments; and the further steps and methods whereby at least one Official provides each Voter with at least one method, and at least one opportunity, to accept or reject the accuracy of any amended records, tallies, summaries, calculations, or publications; and the further steps and methods whereby any number of Voters verify correctness or report errors in the amendment to any number of Officials; and the further steps according to claims 1 to 13 whereby at least one Official records and provides a receipt for each Eligible Voter of claim 12, or, to each Voter of claim 1,2,3, or to any number of Officials, requesting investigation of errors or omissions pertaining to Voter Registrations (Master, Primary, Receipts) or Ballots (Master, Primary, or Receipts) or both Voter Registrations and Ballots, along with all relevant details, then Officials or their designated agents proceed to investigate whether to accept or reject each Voter request to amend any errors, record the Official findings of the investigation, and when required, Officials amend any number of disputed records, tallies, summaries, calculations, and publications (such as, but not limited to: FIG. 16,17A,17B) for any number of Voter Registrations (Master, Primary, Receipts) or Ballots (Master, Primary, or Receipts), Master Ballot Containers, Voter Information Containers, in accordance with the findings and Voting Session Rules, then any number of times, Officials verify each amendment was completed accurately, or resubmit any number of amendments, then provide a report (such as, but not limited to: FIG. 16, 17A, 17B) to each complainant Voter and any number of other interested parties for example, but not limited to: the news media).

17. The steps and methods according to claims 1 to 16 whereby Officials and Voters repeat any number of steps 1 to 16, any number of times, for any number of voting entities, non-voting entities or officials until satisfactorily completing all requirements according to Voting Session Rules; and the further steps and methods of claims 1 to 16 and this claim whereby Officials then verify, validate, certify then finalize then publish the final amended records, tallies, calculations, summaries and reports for Voter Registrations, Ballots, and any other relevant aspect of the Voting Session, and the further steps and methods of providing any number of information items (such as, but not limited to: list of all Eligible Voters, list of all BALLOT VOTING RSIDs) to Voters, political candidates, and interested third parties (such as, but not limited to: news media, non-partisan vote auditors, non-voters) in accordance with the Rules of the Voting Session; and the further steps whereby at least one Official declares the current Voting Session completed/closed.

18. The inventor also claims the further steps, and methods, as another embodiment or application of this invention, as previously filed by this inventor in U.S. patent Pending Ser. No. 11/160,003 for which the inventor also claims foreign filing priority according to the Paris Convention Treaty for Canadian Patent Pending 2,700,498 whereby: the steps and methods according to (but limited to) claims 1-19 of this invention include any further methods of providing, tracking, auditing, tallying and reporting any type of and any number of RSID's according to (but not limited to) claim 3, correlating any number of barcodes or other symbolic codes to each Random RSID, any number of Security Elements according to (but not limited to) claim 6, any number of steps and methods of processing according to (but not limited to) claims 1 to 17, to any number of objects (such as, but not limited to: documents, money orders, monetary currency, vehicles, electronic mail, electronic files, internet webpages) in any number of formats (such as, but not limited to: electronic file, internet webpage, printed paper, embossed plastic) to enable any number and any type of actions—such as, but not limited to: object registration, tracking, auditing, determination of existence/status, recording events, statistical analysis (such as, but not limited to: locations, timing, frequency), signaling messages, generating reports of events or analysis.
